(19) United States
(12) Patent Application Publication
(10) Pub. No.: US 2025/0171972 A1
(43) Pub. Date: May 29, 2025

(54) ARTIFICIAL REEF APPARATUS, SYSTEM, AND METHOD

(71) Applicant: Florida Institute of Technology, Inc., Melbourne, FL (US)

(72) Inventor: Robert J. Weaver, Indian Harbour Beach, FL (US)

(21) Appl. No.: 18/960,894

(22) Filed: Nov. 26, 2024

Related U.S. Application Data
(60) Provisional application No. 63/603,463, filed on Nov. 28, 2023.

(51) Int. Cl. E02B 3/04; A01K 61/73

(52) U.S. Cl. CPC E02B 3/046; A01K 61/73

(57) ABSTRACT

A customizable artificial reef for protecting shorelines from oncoming waves and creating a natural habitat for marine life is disclosed. Spurs extending seaward abut a line of crests, forming grooves between the spurs. Optional berms abutting a seaward side of the line of crests may be disposed in the grooves. Parameters of the spur-and-groove customizable artificial reef such as spur height, spur length, wavelength, groove width, cross-shore slope, submerged depth, and the reef crest width are selected to achieve a desired hydrodynamic and circulation of ocean water effect in the SAG reef area. Coral growth on the reef surfaces cover portions, and preferably all, of the SAG reef surfaces, and self-adapt to grow to an optimal height above the SAG surfaces. After storm damage, the SAG reef self-heals through coral re-growth. Spur, crest, and berm sections may be cast individually or may be configured using a plurality of reef modules for ease of manufacturing, transport, and installation.

### REFERENCE

This U.S. Nonprovisional Patent application claims benefit of priority to U.S. Provisional Patent Application No. 63/603,463, titled SPUR AND GROOVE ADAPTIVE REEF MIMIC (SAGARM), filed in the United States Patent and Trademark Office (USPTO) on Nov. 28, 2023, which is hereby incorporated by reference herein in its entirety.

### STATEMENT REGARDING FEDERALLY SPONSORED RESEARCH OR DEVELOPMENT

Not applicable.

### FIELD OF THE INVENTION

The present invention is directed to a novel wave attenuation system which also provides an environment for encouraging marine life. In particular, an artificial reef that provides wave dampening to protect an associated shoreline from erosion, while also providing a structure fostering marine life. The overall structure of the artificial reef is modeled after a category of natural reef known as a spur-and-groove (SAG) reef.

### BACKGROUND

Shorelines around the world are increasingly at risk from sea level rise. While rising sea levels are threatening coastal stability, storms are also becoming more frequent and severe with larger waves that will have a greater impact on a shoreline's structure. Given that approximately 3 billion people live on or near the coast, there is high demand to protect the property and homes in these areas. Typical structures that emerge above the water surface commonly used to mitigate coastal erosion include groins, seawalls, and emergent breakwaters. However, these structures are costly to build, visually unattractive and disrupt the natural marine environment. Submerged breakwaters, on the other hand, do not disrupt the aesthetics of the beach while also allowing for normal along-shore sediment processes to occur with smaller waves. As wave height increases, there is more interaction between the submerged breakwaters and the incoming waves, which is crucial for a breakwaters' role in mitigating shoreline damage. Extensive research and development in designing breakwaters has been done in the past hundred years. However, nature has long before established reefs as effective natural breakwaters worldwide.

Amongst the different type of reef formations, naturally occurring spur-and-groove (SAG) reefs are specifically noted for their ability to act as natural breakwaters that regulate hydrodynamic energy and promote optimal nutrient flows to encourage life on the reef platforms. The overall structure of a SAG reef is composed of one or more reef crests and multiple large ridges (spurs) separated by sections of sediment floor (grooves) that typically start seaward of a reef crest located near the shoreline, and extend seaward into deeper water down the reef slope. Referring to FIG. 1, a typical naturally occurring SAG reef at Sombrero Key in the Florida Keys is shown.

The geometry of naturally occurring SAG reef zones has been well documented, but not until recently have the hydrodynamics been 3D modeled and studied thoroughly. Research shows that natural SAG geometry is correlated to the local incident wave conditions and that certain specific SAG reef geometric characteristics affect hydrodynamics and circulation of ocean water within a SAG reef system. The geometry of an artificial reef structure involves an array of design parameters, including but not limited to: spur height, spur length, spur wavelength, groove width, cross-shore slope, reef crest width.

Global coral reef populations have been declining all around the world, with a recent study stating that current living reef coverage has declined by 50% since the 1950s. These ecosystems provide food, job opportunities, carbon sequestration, and coastline protection from extreme climate events.

SAG reefs consist of distinctive ridge-like structures (“spurs”) with adjacent sandy bottom channels (“grooves”) that are typically orthogonal to the shoreline. Typically, SAG reefs are more common in higher wave energy condition areas where they act as natural breakwaters. While SAG reefs protect the shoreline from erosive waves, the corals on the structure additionally benefit from the increased water motion that promotes mass transfer and an influx of nutrients into the system, which can facilitate faster growth rates of corals.

With the wide variability in locations of SAG reefs, there is a significant range in the scales of these structures, with spur height ranging from 0.5 to 10 m, SAG wavelength ranging from 5 m to 150 m or greater, groove width ranging from 1 m to 100 m or greater, and depths that the SAG zones are found in ranging from 0 to 45 m or greater. The spur and groove “wavelength” defines the alongshore distance from the longitudinal axis of one spur to the longitudinal axis of its adjacent spur(s). That is to say, a pair of spurs may be separated by a wavelength. A SAG artificial reef of the invention may extend along the seabed parallel to the shoreline, submerged at a desired depth, for a total distance of n wavelengths.

Given the wide variability in dimensions of SAG reef structures, there is also variability in hydrodynamic patterns and wave height reduction amongst different reef systems. It has been noted that taller spurs and larger wave heights coincide. SAG reefs play a critical role in wave attenuation and there is potential for significant loss/damage to coastal shorelines if these SAG ecosystems collapse due to environmental changes.

A typical cross-section of a submerged rubble mound breakwater is shown in FIG. 2. Submerged breakwaters typically consist of low crested shore-parallel rubble-mound structures that are at or below the mean water line with the main purpose to attenuate wave energy and reduce shoreline erosion. Breakwaters accomplish this goal via wave breaking, wave reflection, wave refraction, and turbulent dissipation. Even if the submerged breakwater fails to induce wave breaking, wave refraction will still occur which can reduce erosional alongshore currents. When waves approach a shoreline at an angle, they can create currents that will transport a greater amount of sediment in the alongshore direction. Waves tend to become more normal to the shoreline as they enter shallower water; therefore, a submerged breakwater can induce wave refraction earlier and reduce those alongshore currents.

These structures have been used successfully to protect harbors from wave energy and prevent coastal erosion. Due to the lower crest as compared to an emergent structure, submerged breakwaters can be more economically feasible when a project does not require complete protection from waves. Other benefits when compared to its emergent counterpart include proper flushing and circulation in the lee of the structure, improved aesthetics since the breakwater does not disrupt the natural setting, and more effectiveness in wave height reduction for larger waves.

Referring to FIGS. 3 & 4, in relation to wave transmission, a submerged breakwater is most effective in wave height reduction with larger wave heights, shorter wave periods, wider structure crests, and decreased structure crest submergence levels.

Referring to FIG. 5, in terms of shoreline response, detached submerged breakwaters can induce the formation of salients or tombolos. A salient consists of sediment deposition in the lee of the structure that remains submerged and does not fully disrupt alongshore transport. Tombolos become present when sediment accumulates and completely blocks off along-shore sediment transport, which is more likely to occur when breakwaters are emergent, close to the shore, longer than the incident wavelength, and relatively impermeable.

Reef Balls™ (U.S. Pat. No. 5,564,369 and depicted in FIG. 6) are common artificial reef structures that can be designed for specific species recruitment and are an economical option. While the main objective of Reef Balls™ is to create habitats for corals, they have also been shown to induce accretion at shorelines. These structures, however, are not applicable for deeper water and larger waves given that their maximum height is roughly 2 to 2.5 m.

Coastal erosion is a constant threat to the Earth's coastlines, even more so now with rising seas. Other climate change impacts include increasing seawater temperatures and ocean acidification which are negatively impacting coral reefs. With the increasing demand for coastal protection and ecosystem creation as coral reefs are dwindling, scientists and engineers need to start approaching coastal protection structures with more sustainable thinking by creating structures that encourage life while also protecting the coastlines.

Therefore, what is needed in the art are systems, methods, and apparatuses that can protect coastlines from incoming wave damage while also providing a habitat that supports and fosters indigenous environmental life, especially in the presence of larger incoming waves, and that is self-adaptable to changes in sea level.

### SUMMARY OF THE INVENTION

An object of the present invention is to provide systems, methods, and apparatuses for a new customizable artificial reef that can provide wave attenuation as well as new habitats for coastal ecosystems. An artificial SAG reef structure may be referenced herein throughout as “SAGARM”, meaning Spur and Groove Artificial Reef Mimic.

In embodiments, the invention mimics naturally occurring SAG reef tracts and is operable to protect vulnerable coastlines while also adding an essential ecosystem that encourages marine life growth. Additionally, the invention can readily self-adapt to local conditions to reduce long-term maintenance costs, by the naturally occurring growth of algae and corals on the artificial reef structure. Not only will the corals grow in a way tuned to the local wave conditions, but they will also grow vertically and laterally creating more complex surface area while adjusting for local sea level rise. Corals and encrusting coralline red algae build up reefs via internal marine precipitation of aragonite and magnesium calcite, and this process is expedited based on the influx of fresh and turbulent seawater. When extreme weather events happen and some corals are damaged, the artificial reef, which may be considered a “living breakwater”, has a strong concrete base with the ability to self-heal. This integrated and diverse ecosystem approach could exceed the design life of other man-made structures, create a hotspot for fishing and tourism, and rehabilitate an ecosystem type that is dwindling.

Referring to FIGS. 7 & 8, the overall structure of a non-limiting embodiment SAG reef is composed of multiple large ridges (“spurs”) 100, each one separated from its neighbor by a gap (“groove”) 103 extending to the (typically sandy) seafloor. The reef crest 102 is nearest the shoreline and the spurs 100 and grooves 103 extend distally from the reef crest into deeper water down the reef slope. In embodiments, there exists a berm 101 (in embodiments smaller in scale than the spur) that extends out into the groove 103 from the crest 102. This berm 101 may be integrated into the crest 102 or be independent from the crest 102.

In embodiments, the SAGARM system may be an engineered coral-independent reef ecosystem hybridized with a manufactured substrate, based on repeating reef modules (See FIGS. 9-18) that mimic coral-reef geomorphology common in high-wave-energy environments worldwide. The SAGARM may be modular in design, meaning that a plurality of the modules can be assembled (i.e., mated) together to form a range of configurations, for example and not meant to be limiting, one or more “spur” sections, “crest” sections, and optional “berm” sections. In embodiments, these sections may also be separately and independently manufactured without using reef modules, for example, the different sections may be manufactured in their entirety from concrete. Embodiments not utilizing individual reef modules may be constructed on-site from riprap encapsulated in concrete poured in place. A person of ordinary skill in the art would also appreciate that different sections (or an entire artificial SAG reef structure) may be constructed off-site (e.g., in a dry dock) and floated to an installation site before being submerged.

The invention is novel in its capacities to self-heal, naturally encrust, and accommodate multi-species out-planting of farmed coral fragments over a range of depths and starting conditions.

Amongst the different type of reef formations, SAG reefs are specifically noted for their ability to act as natural breakwaters that regulate hydrodynamic energy and promote optimal nutrient flows to encourage life on the reef platforms.

An object of the present invention is to protect shorelines far longer than the systems in the current art. In embodiments, the invention is modular and geographically transferrable. The SAGARM system integrates multi-scale habitat/ecosystem elements that will create long-term environmental stability in varied locales by stimulating genetic and morphological diversity. This diversity and resultant self-healing properties built into both the structural and living components, will increase adaptation to local conditions and greatly reduce long-term maintenance costs.

The SAGARM design incorporates a heterogeneity of habitats built into the design, the irregular shapes and sizes incorporated into each module creates a mosaic of environments, fostering biodiversity by accommodating organisms with different habitat preferences.

Embodiments of an artificial reef structure, and the reef modules that may be used to form an artificial reef structure, incorporate a diverse range of habitats, including crevices, holes, and spaces between reef modules that mimic the spaces between naturally occurring coral branches or rocks. These habitats vary in size, from small crevices that can accommodate tiny invertebrates to larger spaces suitable for fish and other larger organisms. Fractal dimensions ranging from 1.7-1.95 and up to as much as 2.5 will be used in the design to represent the complex and self-repeating structures observed in these ecosystems. The micro-scale and meso-scale habitat features are created in the design of each reef module. The concrete making up each reef module has surface rugosity designed into the module with roughness scales from the micro- to meso-scale. Keying features of the reef modules provide meso-scale to macro-scale habitat features, and finally the rounded edges of the modules result in a fitment that creates macro-scale holes, cracks, and deep channels into the structure. These features are unique to the inventive modules, and artificial reef structures formed from these modules.

Micro-scale habitat reef module surface features support the settlement and recruitment of planktonic juvenile organisms, and at this scale will have dimensions on the order of millimeters to centimeters.

Meso-scale habitat reef module features are designed to support the small to medium-sized organisms and include small caves, crevices, channels, and hiding spots. These features will range from centimeters to decimeters in size and will depend on the targeted organisms.

Macro-scale habitat reef module features (e.g., caverns and caves) accommodate larger fish and predators and will have dimensions ranging from decimeters to meters, depending on the size of the targeted marine life. In embodiments, the macro-scale habitat features are formed by joining reef modules together to build up one or more spur sections, crest sections, and/or berm sections.

In embodiments, reef scale (i.e., macro-scale) habitat features are achieved by assembling the spur sections, crest sections, and berm sections into an artificial reef structure. An artificial reef structure at the scales of meters to tens of meters will provide the habitat and induce the circulation needed for the development of a healthy ecosystem.

The incorporation of multi-scale roughness features are implemented into the invention based on the manufacturing techniques used. In embodiments, reef modules may be manufactured using dry-casting, wet-casting, or 3D concrete printing. Reef modules that will be placed in an exposed configuration (i.e., surface/exterior modules) have multi-scale surface roughness features. In embodiments, reef modules placed in an interior configuration may be identical to the surface modules or may be of simpler design. For example and not meant to be limiting, the first inner layer of reef modules may be comprised of cast concrete with larger scale features (e.g., holes) to minimize material use, allowing for fluid flow through the structure and facilitating growth of a marine habitat. In embodiments, a central core of an artificial reef structure may be crushed limestone and riprap, providing the support for the outer layer modules.

In embodiments, reef modules that make up a larger artificial reef structure are designed to be customizable, modular, interlocking, and stackable-achieved through one or more keying features of each module. Keying features may be based on a variety of designs that enable reef modules to be joined without the use of fasteners. For example, and not meant to be limiting, keying features may be spherical designs, dovetail designs, tongue and groove designs, etc., The implementation of keying features facilitate ease of fit and enhance resistance to lifting and separating. Embodiments of keying features are designed to have the most flexibility in allowable stacked configurations. In embodiments, keying features may double as feet designed to imbed in the sea floor or base/bedding material to increase friction and resist sliding.

In embodiments, manufacturing techniques provide the ability to cast individual sections or a whole artificial reef structure in their/its entirety in situ, either by 3D printing or casting. In this case there may be no reef modules to assemble and place. The surface roughness features will be cast in place and the total volume of material used may be reduced by setting an infill parameter or casting over a core as described above. It is also possible to cast the complete artificial reef structure including all the rugose design features in a dry-dock and then float the reef to the deployment site, and sink as one unit, much as is done with large concrete Caisssons used for port and breakwater construction.

An artificial reef structure of the invention may comprise a combination of one or more spur sections, crest sections, and berm sections. The design of the reef modules described herein allows for the modification of the dimensions of a reef section based on water depth and incident wave properties (e.g. wave period, wavelength, and wave height). The length of an artificial reef (parallel to the shoreline) and the ratio of spur to groove may be determined on a site-by-site basis based on the design needs of the project.

An artificial reef structure of the invention mimics naturally-occurring SAG reef tracts, protecting vulnerable coastlines while also enabling the establishment of an essential ecosystem. Additionally, an artificial reef structure is able to readily adapt to local wave and other conditions to reduce long-term maintenance costs. Not only do the corals settling on the artificial reef structure grow in a way tuned to the wave conditions, but they also grow vertically and laterally creating more complex surface area while adjusting for sea level rise. Encrusting coralline red algae builds up reefs via internal marine precipitation of aragonite and magnesium calcite, and this process is expedited based on the influx of new seawater. When extreme weather events happen and some corals are damaged, the artificial reef structure will have the ability to self-heal. This integrated and diverse ecosystem approach could exceed the useful life of other man-made structures, create a hotspot for fishing and tourism, and rehabilitate an ecosystem type that is rapidly dwindling.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating exemplary embodiments of the invention and are not to be construed as limiting the invention. In the drawings:

FIG. 1 depicts a photograph of a representative naturally occurring SAG reef formation on Sombrero Key taken from Google Maps. Example spur and groove identified in image along with the incident wave direction.

FIG. 2 depicts a typical cross-section of a submerged rubble mound breakwater noting the depth (d), height of structure (hₛ), submergence depth (dₛ), and the crest width (B).

FIG. 3 depicts plots showing the relationship between wave height, wave period, and submergence depth (dₛ) in a constant depth.

FIG. 4 depicts plots showing the relationship between wave height, wave period, and crest width (B) in a constant depth.

FIG. 5 depicts an example schematic of detached breakwaters showing resulting tombolo and salient formations.

FIG. 6 depicts a traditional Reef Ball™ known in the prior art. (U.S. Pat. No. 5,564,369)

FIG. 7 depicts a perspective view of an embodiment of a submerged breakwater/artificial reef of the invention.

FIG. 8 depicts a top view of an embodiment of a configuration of a submerged breakwater/artificial reef of the invention.

FIG. 9 illustrates an embodiment of an artificial reef structure of the invention using a plurality of reef modules assembled into spur sections, crest sections, and berm sections.

FIG. 10 illustrates a perspective view of an embodiment of a reef module.

FIG. 11 illustrates an orthogonal view of an embodiment of a reef module.

FIG. 12 illustrates another orthogonal view of an embodiment of a reef module.

FIG. 13 illustrates another orthogonal view of an embodiment of a reef module.

FIG. 14 illustrates another orthogonal view of an embodiment of a reef module.

FIG. 15 illustrates another orthogonal view of an embodiment of a reef module.

FIG. 16 illustrates another orthogonal view of an embodiment of a reef module.

FIG. 17 illustrates a perspective view of a plurality of reef modules.

FIG. 18 illustrates another perspective view of a plurality of reef modules.

FIG. 19 depicts a plot showing significant increase in wave height reduction as wave height increases which is likely attributed to the larger wave heights having more energy to be dissipated. Note that wave height reduction here includes wave shoaling; therefore, dissipation is not fully attributed to the structure.

FIG. 20 depicts plot showing the inverse relationship between wave height reduction and submergence.

FIG. 21 depicts a plot showing increased wave height reduction as spur length increases.

FIG. 22 depicts a plot showing wave height reduction vs. groove width for the new base case scenario showing a decrease in wave attenuation as groove width increases for an embodiment of the invention.

FIGS. 23A-23C depict a visualization of domain setup for simulations. a. physical dimensions based on a reef in Moloka'i, Hawaii. B—FLOW-3D® HYDRO arrangement of SAG model (yellow) on sloping bed (grey). Probe locations in the groove and adjacent to structure are indicated by red dots. C—The entire model domain for simulation in FLOW-3D® HYDRO with SAG model in yellow and sloping bed in grey with probe locations indicated by the dots.

FIG. 24 depicts an aerial view of new base case scenario showing adjusted spur and crest modules with new slopes and a side view of new base case scenario showing the low tide condition and consistent submergence between the top of the spur and the mean water level.

FIGS. 25A-25C depict wave breaking locations and z-velocity streamlines under varying wave heights with constant wave period of T=10s. In FIG. 15A H=0.5 m wave condition where no wave breaking occurred on the structure and minimal z-velocities were observed. In FIG. 15B H=2 m wave condition where wave breaking occurred on the crest module and negative z-velocities were observed. In FIG. 15C H=4 m wave condition where wave breaking occurred before the crest module and negative z-velocities were observed.

FIGS. 26A-26B depict plots showing wave breaking and turbulent dissipation changes in low tide and high tide conditions with the green line in the bottom plots indicating the time at which the upper images are shown. FIG. 26A-Groove cross-section during the low tide condition correlated to a transmission coefficient of 0.60 where higher turbulent dissipation was observed in the berm area (red) and spur surface (blue). FIG. 26B-Groove cross-section during the high tide condition correlated to a transmission coefficient of 0.69 where negligible values of turbulent dissipation were observed. Showing increased wave height reduction as spur length increases.

FIG. 27 depicts a plot showing wave height reduction vs. spur width. The first test adjusted mesh width for each spur width and only had two spurs and one groove in each simulation. The second test maintained the largest mesh width for the 10 m spur and inputted as many spurs and grooves as possible into the mesh for the 2.5 m and 5 m cases.

FIG. 28 depicts a plot showing a full set of varying wave conditions results for new base case scenario setup showing overall wave height reduction from the bed and reef.

FIG. 29 depicts a plot showing a full set of varying wave conditions results for new base case scenario setup showing wave height reduction solely due to the structure.

FIG. 30 depicts a plot showing wave height reduction vs. submergence with the reef and without the reef present.

FIG. 31 depicts a plot showing evidence of potential scour from the formation of an eddy due to wave breaking in the lee of the structure.

FIG. 32 depicts plots showing eddy formation in the lee of the structure with the new base case scenario. The upper image shows fluid x-velocity streamlines with waves propagating from left to right, and the lower image provides a plot of the fluid x-velocities at probe 3, the red dot behind the sloped crest module. The vertical green line represents the time at which the upper image is showing as well as the point on the plot in the bottom image.

FIG. 33 depicts plots showing varying fluid x-velocities within the groove when flow is onshore in the artificial SAG reef. Upper left image shows a side view of the reef looking into the groove with fluid x-velocity streamlines and probes represented with red dots. Upper right image shows an aerial view of the reef with fluid x-velocity streamlines. The bottom plot shows fluid x-velocities from the groove bottom probe data (purple line) and the groove surface probe data (blue line). For the groove surface probe, velocities went to zero when the probe was out of the water. The vertical green line represents the time at which the image is taken.

FIG. 34 depicts plots showing varying fluid x-velocities within the groove when flow is offshore in the artificial SAG reef. Upper left image shows a side view of the reef looking into the groove with fluid x-velocity streamlines and probes represented with red dots. Upper right image shows an aerial view of the reef with fluid x-velocity streamlines. The bottom plot shows fluid x-velocities from the groove bottom probe data (purple line) and the groove surface probe data (blue line). For the groove surface probe, velocities went to zero when the probe was out of the water. The vertical green line represents the time at which the image is taken.

FIG. 35 depicts results for sensitivity runs on changes in submergence including control runs that had set submergence values without the reef present.

FIG. 36 depicts results for sensitivity runs on changes in wave period including control runs that had set wave period values without the reef present.

FIG. 37 depicts results for sensitivity runs on changes in wave height including control runs that had set wave height values without the reef present.

FIG. 38 depicts results for sensitivity runs on changes in spur length including control runs that had set base wave and submergence conditions without the reef present.

FIG. 39 depicts results for sensitivity runs on changes in crest length including a control run that had set base wave and submergence conditions without the reef present.

FIG. 40 depicts results for sensitivity runs on changes in groove width including a control run that had set base wave and submergence conditions without the reef present.

FIG. 41 depicts results with the new base case reef on changes in spur length including control runs that had set base wave and submergence conditions without the reef present.

FIG. 42 depicts results with the new base case reef on changes in groove width including a control run that had set base wave and submergence conditions without the reef present.

FIG. 43 depicts results for first test with the new base case reef on changes in spur width including a control run that had set base wave and submergence conditions without the reef present.

FIG. 44 depicts results for second test with the new base case reef on changes in spur width including a control run that had set base wave and submergence conditions without the reef present.

FIG. 45 depicts results with the new base case reef characterizing various wave conditions and control runs that had set conditions without the reef present.

FIG. 46 depicts additional wave height reduction metrics used for analysis of final testing of various wave conditions on new base case reef.

FIG. 47 depicts an artificial reef structure cast as spur sections, crest sections, and groove sections.

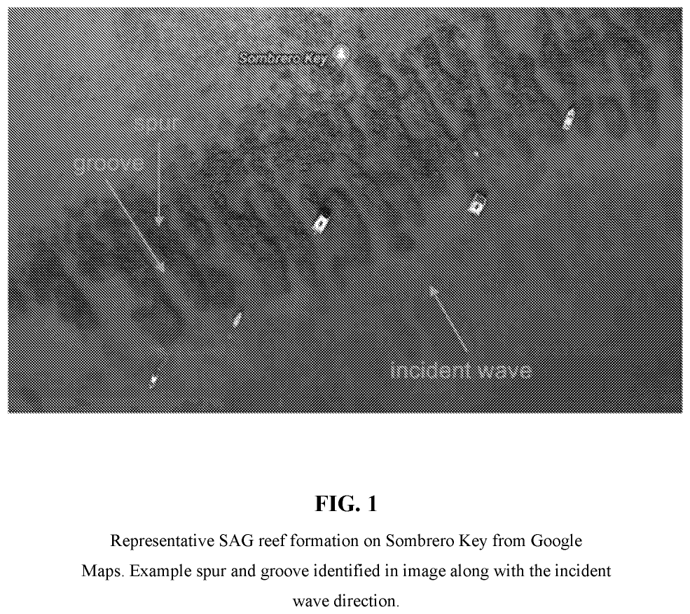

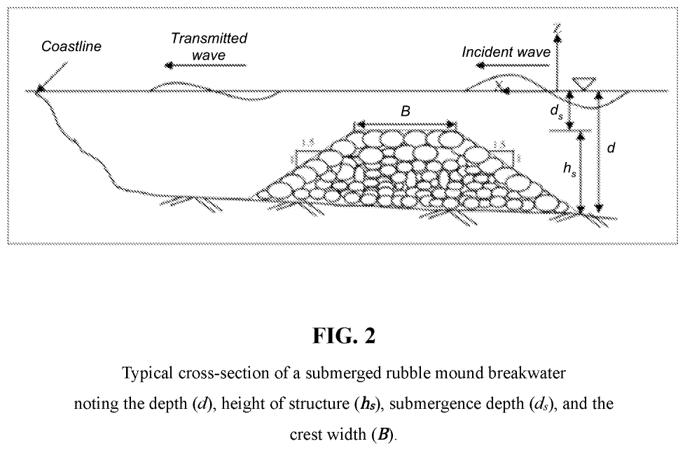

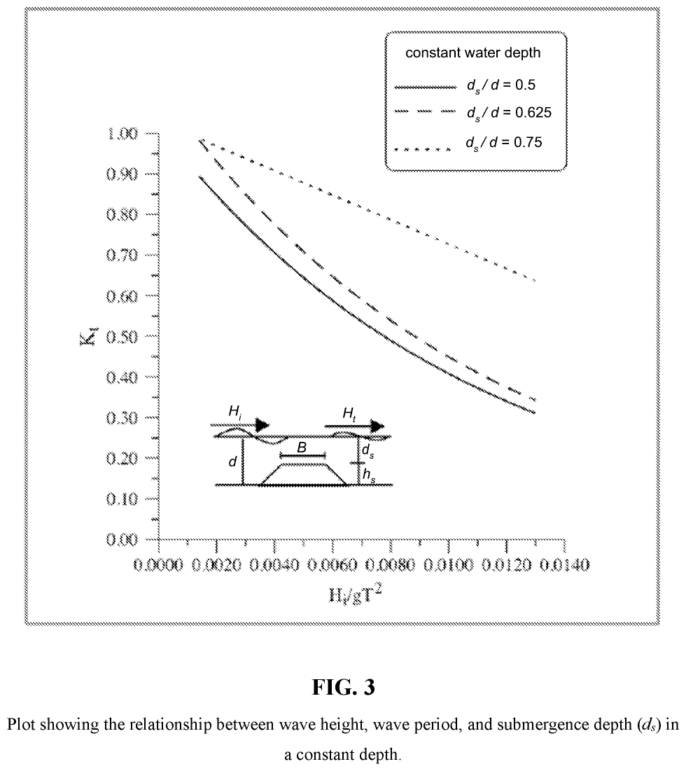

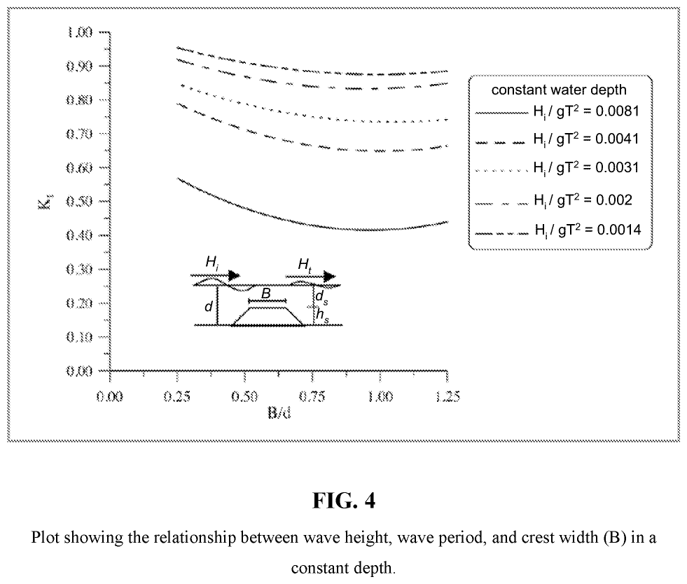

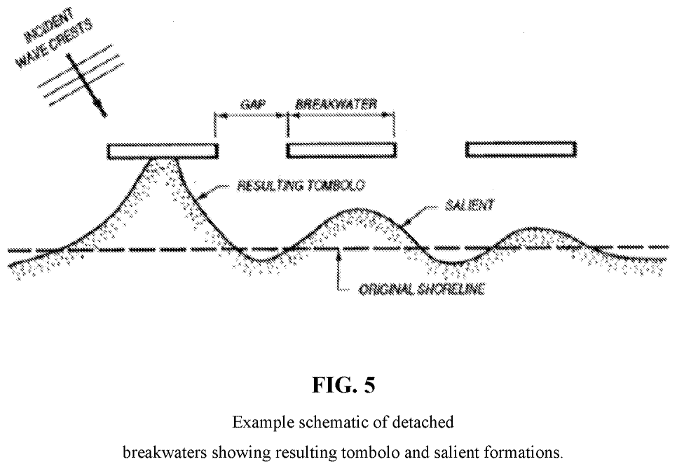

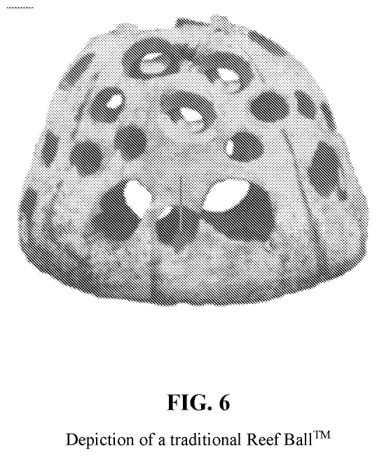

In the Figures of the drawings, like callouts refer to like elements.

### DETAILED DESCRIPTION OF THE INVENTION

The following documentation provides a detailed description of the invention.

Although a detailed description as provided in this application contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus, the scope of the invention should be determined by the appended claims and their legal equivalents, and not merely by the preferred examples or embodiments given.

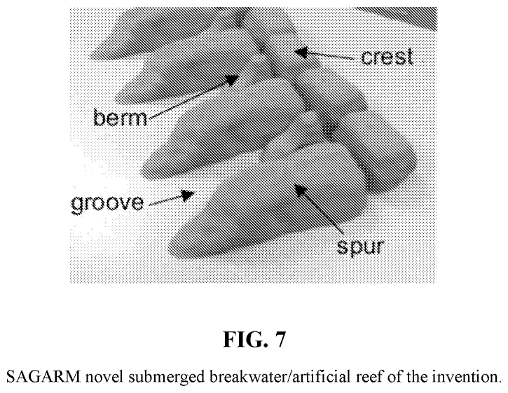

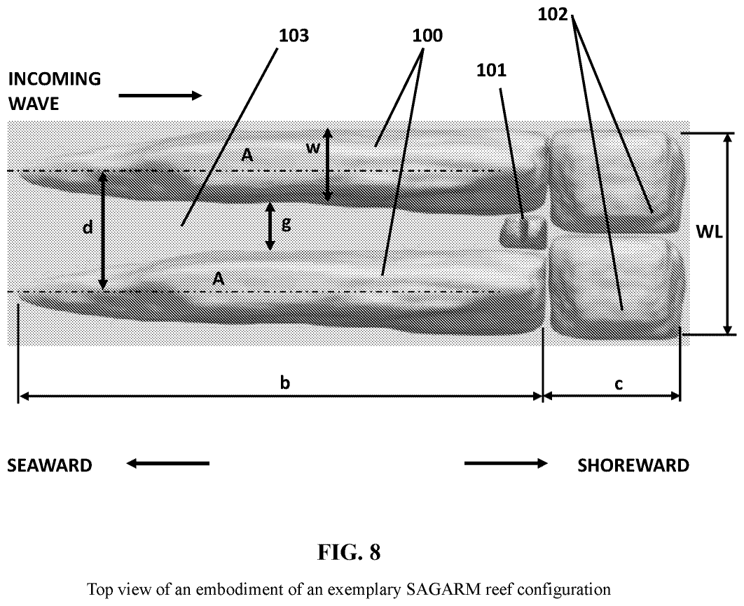

Referring to FIGS. 7 and 8, in embodiments, an artificial reef structure may comprise three different sections: 1) “spurs” 100 extending seaward that initiate wave breaking and circulation; 2) “crests” 102 on the shoreward side of the spurs that operate to dissipate wave energy; and/or 3) optional “berms” 101 located in the groove area that encourage wave-shoaling and mitigate scouring. The spurs 100 may each have a longitudinal axis A. Each spur longitudinal axis A may, but is not necessarily, parallel with longitudinal axis of adjacent spur(s). The spurs may have a width w and may be separated by a distance d, creating grooves of width g. A “SAG zone” may be defined as the area of the SAGARM structure in which the berms 101, grooves 103 and spurs 100 are located. The spurs 100 may have a length b. The crests 102 may have a width c. The arrangement of spur-groove-crest section may comprise any number n of spur pairs so as to extend for any total desired number of wavelengths, n*WL, along the seabed. In the example shown for explanatory purposes in FIG. 8, only two spurs are shown, but this is by way of example only, and is not intended to be a limitation on the scope of the invention. The seaward end of the spurs 100 may comprise a slope, for example but not limited to a 1:1(45°) slope. Berms 101 may also comprise a slope, for example but not limited to, a 1:1(45°) slope, on their seaward side. The height of the structure will be determined by the deployment site conditions and based on the water depth at the location. As a general rule, the top of the structure will be approximately −0.30 m MLLW, or 30 cm below Mean Lower Low Water datum. This will ensure that the structure is submerged in all but the most extreme low water conditions yet minimizing the freeboard of the structure with the goal of maximizing the wave breaking potential.

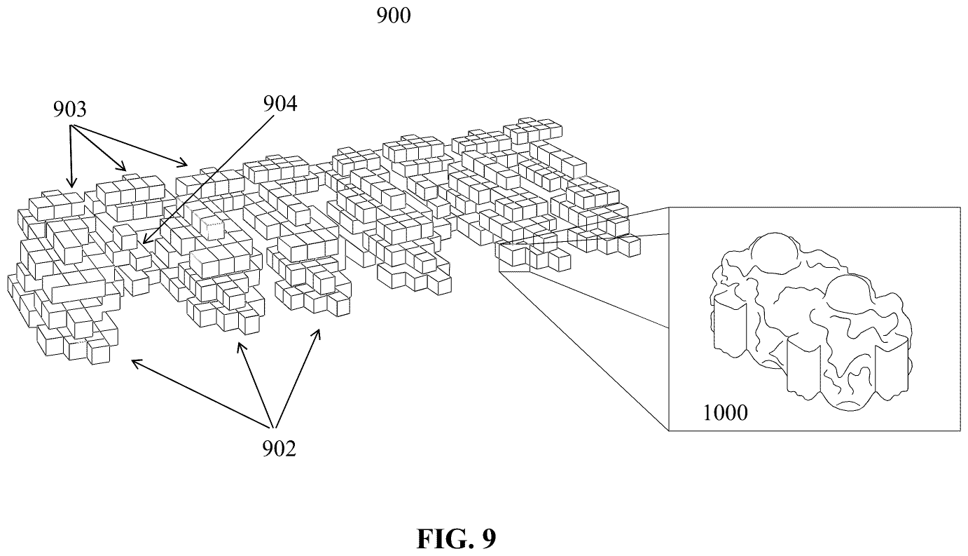

Referring now to FIG. 9, shown is an exemplary embodiment of a customizable artificial reef structure 900 assembled (i.e., one or more surfaces of reef modules proximately disposed or mated) using a plurality of reef modules 1000. The reef modules can be assembled into one or more spur sections 902, crest sections 903, and/or optional berm sections 904. The sections 902, 903, and 904 may be assembled underwater using a plurality of reef modules 901 to form an artificial reef structure. In embodiments, the sections 902, 903, & 904 may be assembled, or mated, from a plurality of reef modules 1000 out of the water (e.g. in a drydock) before being transported to the desired site and submerged.

Referring now to FIG. 10, shown is a perspective view of an exemplary embodiment of a reef module 1000. It is to be expressly understood that, while the exemplary embodiment of the reef module is depicted in the shape of a block, such depiction is for illustrative purposes only and is not intended to be limiting. The invention encompasses reef modules of various shapes, configurations, and geometric profiles, provided that such shapes fall within the scope of the appended claims and effectively perform the intended functions described herein. The depiction of the block-shaped module merely serves to illustrate one possible embodiment and does not restrict the invention to that specific form or structure.

In embodiments, a reef module 1000 comprises one or more surface features 1002 providing micro-scale to meso-scale habitats which promote growth of marine organisms and foster a healthy marine ecosystem. Reef module(s) 1000 may have at least one surface having at least one keying feature for locating or seating (i.e., mating) a first reef module to one or more adjoining reef modules. The keying features may further be defined as first male keying features 1001, first female keying features 1102, second male keying features (not shown), and second female keying features 1003. At least one male keying feature may be disposed on a surface of a first reef module such that it is adapted to be received by at least one complimentarily shaped female keying feature in an opposing surface of an adjoining module.

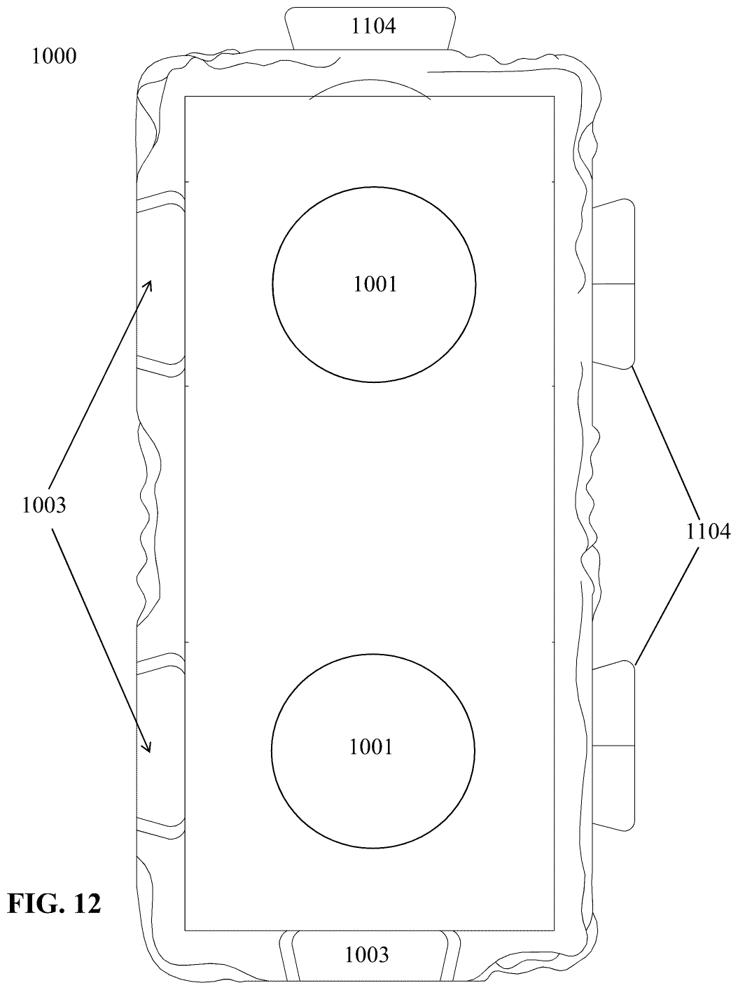

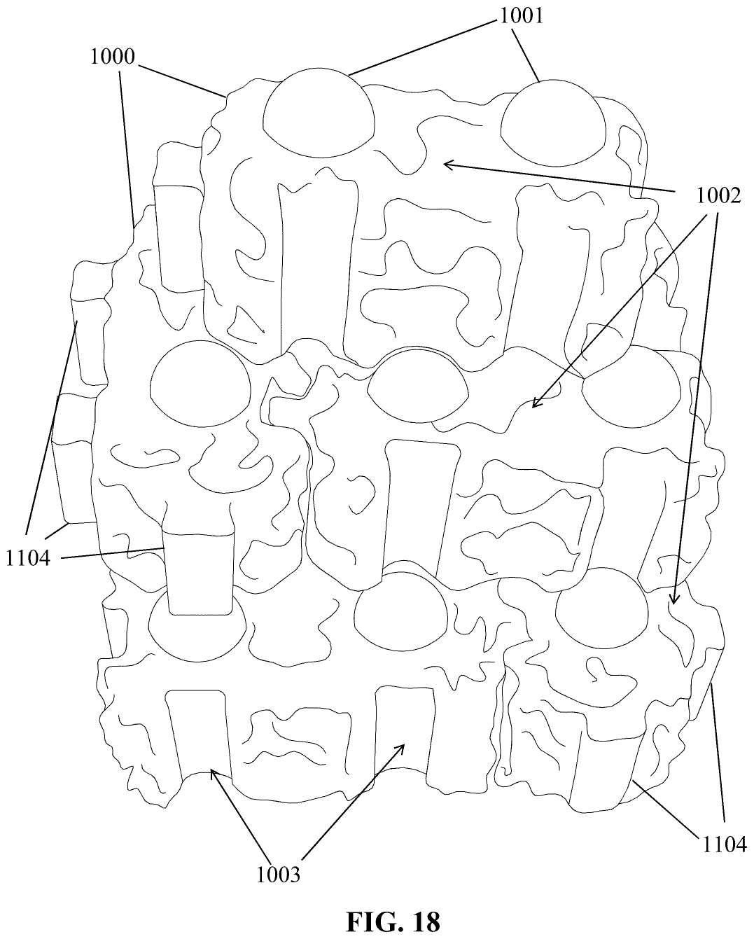

While FIGS. 9-18 illustrate exemplary embodiments incorporating specific keying features such as spherical shapes and dovetail type keying features, these embodiments are provided merely for illustrative purposes and are not intended to limit the scope of the invention. A person of ordinary skill in the art would recognize that keying features of the invention may be realized in a broad variety of shapes and configurations, including but not limited to rectilinear, curved, triangular, polygonal, and specialized geometries. Such variations may be chosen based on the intended application, material properties, or desired mechanical performance, and all such alternatives are within the scope and spirit of the invention as defined by the appended claims. Some non-limiting examples are cylindrical pegs, square pegs, rectangular ridges and grooves, stepped rectangles, circular locks, semi-circular grooves, elliptical pegs, arch-shaped connectors, triangular pegs and sockets, pyramid protrusions, trapezoidal keys, hexagonal pegs, octagonal locks, pentagonal connectors, mortise and tenon configurations, double-locking ridges, wave interlocks, knurled protrusions, star-shaped interlocks, T-shaped projections, L-shaped keys, cross-shaped pegs, and hook-and-recess features.

As can be seen in FIG. 10, reef module 1000 comprises a plurality of first male keying features 1001 (e.g., convex shaped protrusions) for facilitating assembly of a plurality of reef modules into an artificial reef structure. As can be seen, a plurality of surfaces of the reef module 1000 comprise first female keying features 1102 and second female keying features 1003.

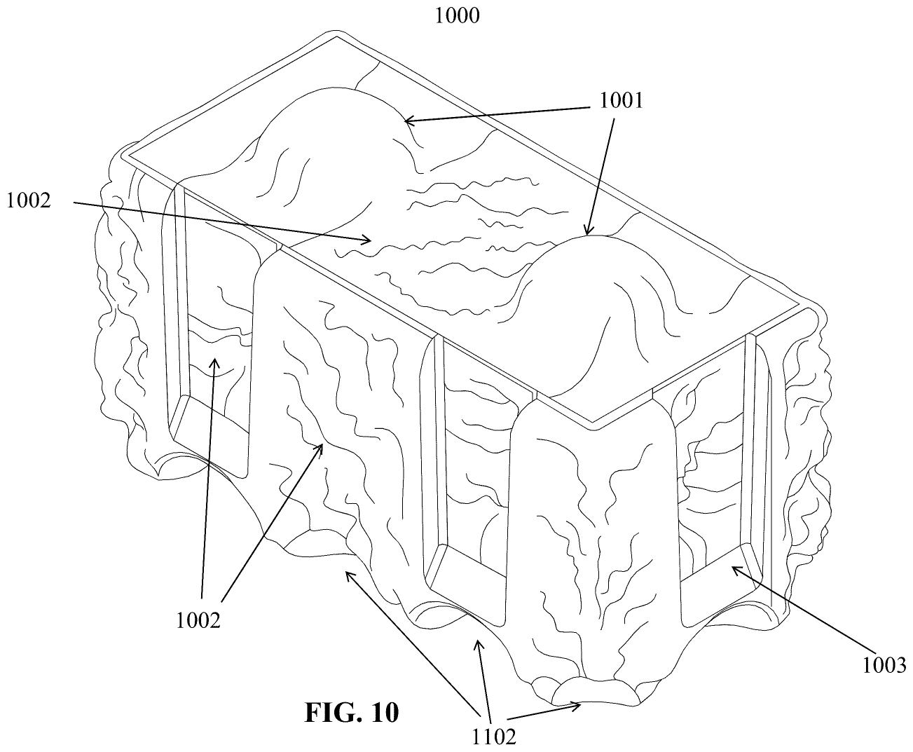

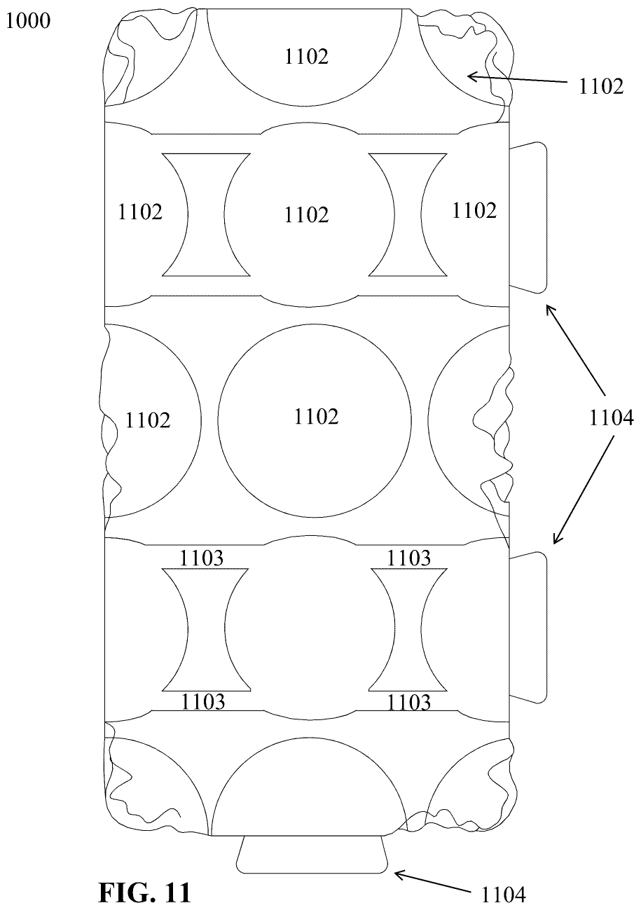

Referring to FIG. 11, in embodiments, a reef module may have at least one surface comprising one or more first female keying features 1102 (e.g., concave shaped recesses) for receiving complimentarily shaped first male keying features 1001 (shown in FIG. 10) of an adjoining module. A person of ordinary skill in the art will appreciate that spherical shapes also encompasses subdivisions into smaller regions, each of which retains some aspect of a sphere's curvature. For example but not limited to, hemispheres, quarter spheres, eighth spheres, etc., Each of these subdivisions maintains the curved geometry inherent to a spherical surface but adds flat boundaries that are defined by the cutting planes.

In embodiments, a reef module surface may further comprise one or more channels 1103 connecting one or more female keying features 1102, 1003 to one another such that marine organisms can move between female keying features when the artificial reef structure is submerged underwater. A reef module 1000 may further comprise one or more surfaces having male keying features. In FIG. 11, second male keying features 1104 protruding from a plurality of surfaces. The number of keying features integrated onto a surface of a reef module is not meant to be limiting and may be in any number and in any combination.

Referring now to FIGS. 10-12, a reef module 1000 may comprise at least one surface having a plurality of first male keying feature(s) 1001 (e.g., spherical protrusions), at least one surface having one or more second male keying feature(s) 1104 (e.g., dovetail), at least one surface having one or more first female keying feature(s) 1102 (e.g., spherical recesses), and/or at least one surface having one or more second female keying feature(s) 1003 (e.g., a groove). In FIGS. 10-12, the one or more first male keying feature(s) 1001 being complementarily sized and shaped to the one or more first female keying features(s) 1102, and vice versa. The one or more second male keying feature(s) 1104 being complimentarily sized and shaped to the one or more second female keying feature(s) 1003. The number of keying features integrated into a surface of a reef module is not meant to be limiting and may be in any number and in any combination.

Referring now to FIG. 13, an orthogonal view of reef module 1000 showing a plurality of keying features. At least one surface of the reef module having one or more surface features 1002 for creating micro-scale to meso-scale habitats. These features provide habitats that promote growth of marine organisms and foster a healthy marine ecosystem. The reef module comprising both a plurality of first female keying features 1102, and at least one second female keying feature 1003 for receiving complimentarily shaped first male keying features 1001 and/or second male keying features 1104 of an adjoining module. In this embodiment, the second female keying feature 1003 comprising a “socket” or “groove” for receiving a complementarily shaped second male keying feature 1104 of an adjoining module.

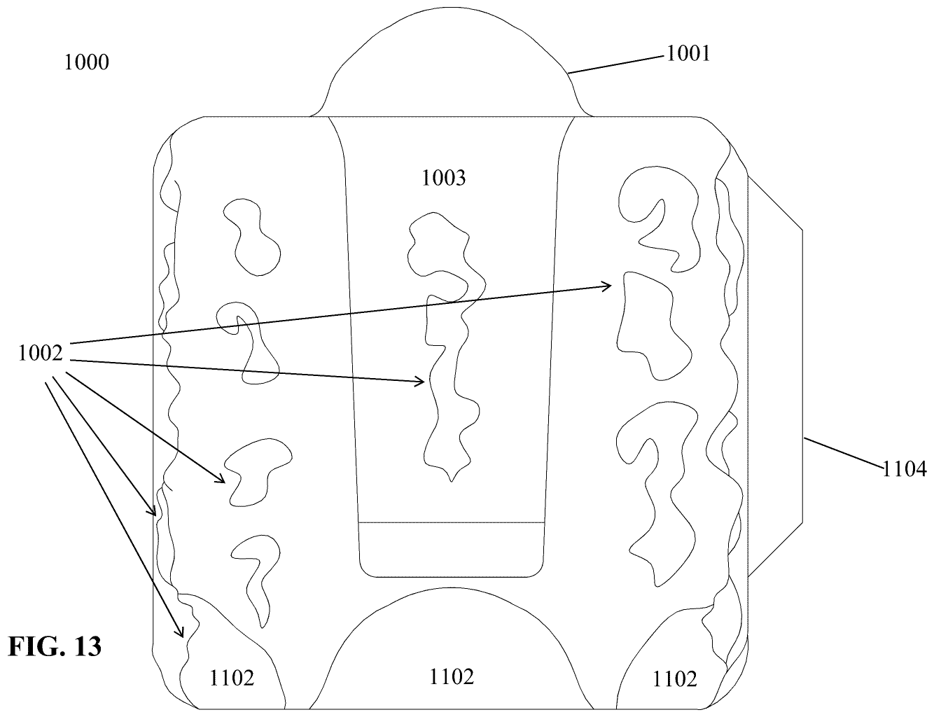

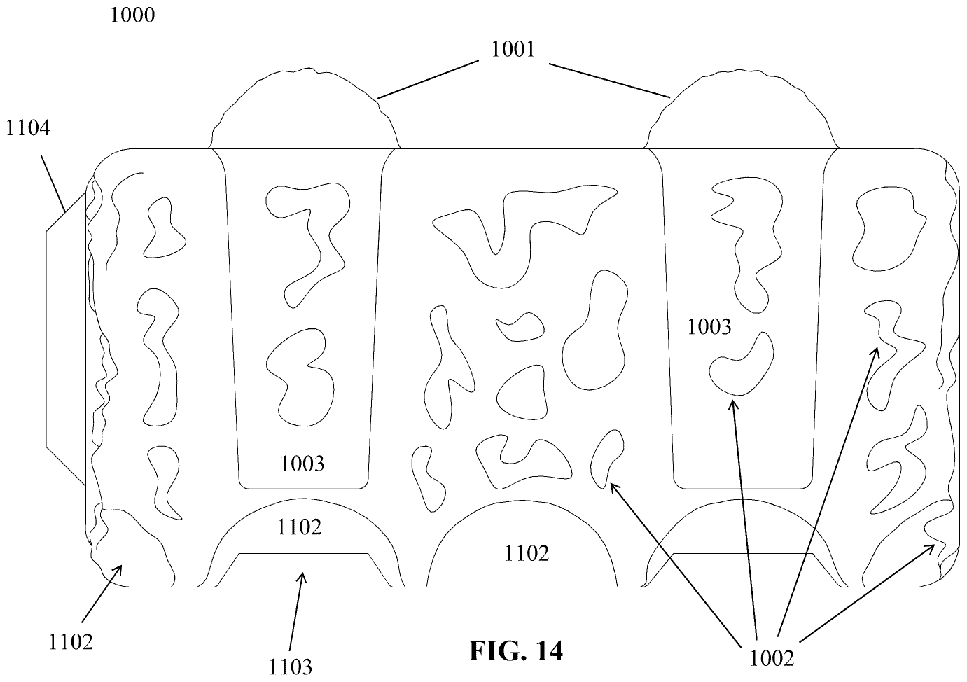

Referring now to FIG. 14, another orthogonal view of a reef module 1000 is shown. The reef module having at least one side having one or more surface features 1002 for providing micro-scale to meso-scale habitats. At least one surface of the reef module comprising a plurality of second female keying features 1003 for receiving one or more complimentarily shaped second male keying feature(s) 1104 of an adjoining module. The surface further comprises a plurality of first female keying features 1102. In this embodiment, the second female keying features 1003 defined as a “socket” or “groove” for receiving a complementarily shaped second male keying feature 1104 of an adjoining module.

Referring now to FIGS. 11 & 14, in embodiments, a reef module 1000 may also have one or more channels 1103 integrated into a surface connecting one or more female keying features to one another such that marine organisms can move between the female keying features when the artificial reef structure is submerged underwater.

Referring now to FIG. 15, another orthogonal view of a reef module 1000 is shown. The surface having one or more surface features 1002 for providing micro-scale to meso-scale habitats. The reef module comprising a plurality of male keying features. A first male keying feature 1001 for receiving one or more complimentarily shaped first female keying feature(s) 1102 of an adjoining module. As can be seen, the reef module further comprises a plurality of second male keying features 1104. In this embodiment, the first male keying feature 1001 being a spherical shaped protrusion for seating into a complementarily shaped first female keying feature 1102 of an adjoining reef module. The second male keying feature(s) 1104 comprising a “tail” or “tongue” shape for seating into a complementarily shaped second female keying feature 1003 of an adjoining reef module.

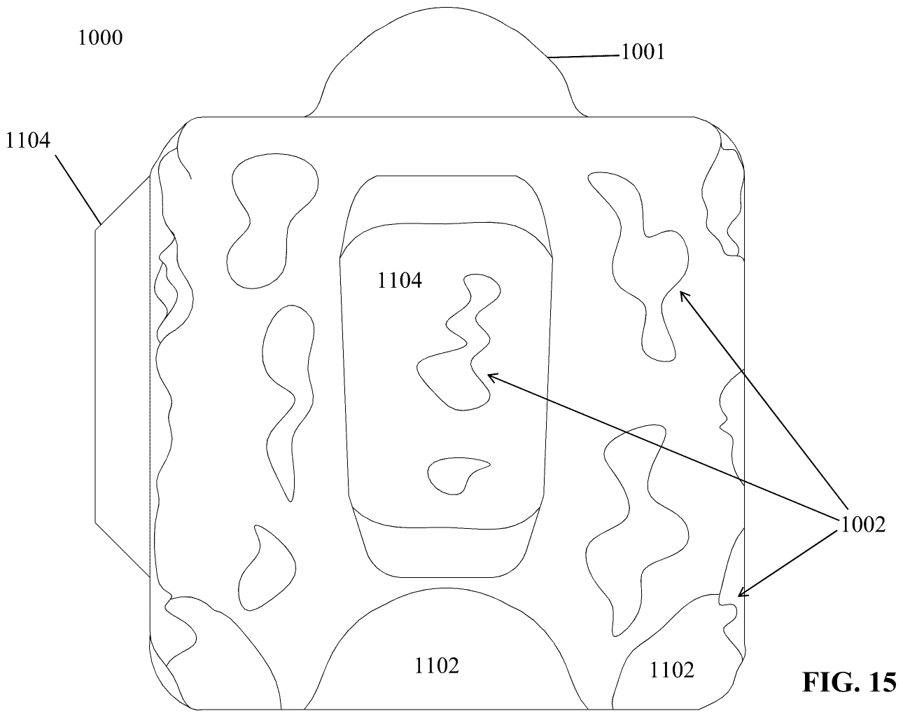

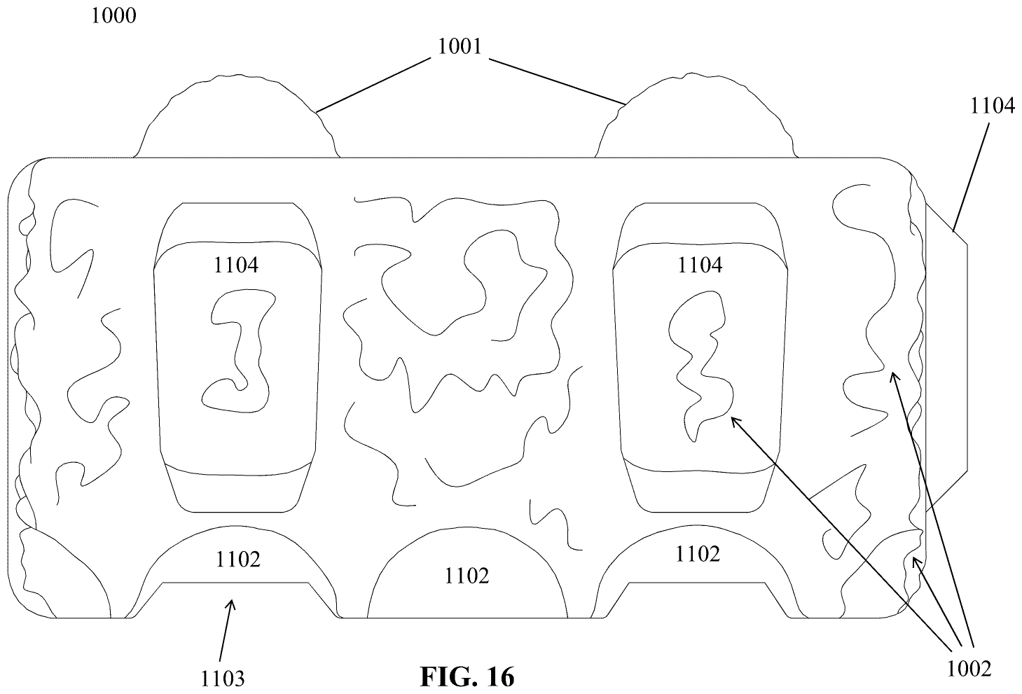

Referring now to FIG. 16, another orthogonal view of a reef module 1000 is shown. The reef module having one or more surface features 1002 for providing micro-scale to meso-scale habitats. The reef module further comprising a plurality of second male keying features 1104 for receiving one or more complimentarily shaped second female keying feature(s) 1003 (see FIG. 14) of an adjoining module. In this embodiment, the second male keying feature(s) 1104 comprising a “tail” or “tongue” for seating into at least one complementarily shaped second female keying feature 1003 of an adjoining module. In this embodiment, a plurality of first male keying features 1001 protruding from one surface and a plurality of second male keying features 1104 protruding from different surfaces.

Referring now to FIGS. 11 & 16, in embodiments, a reef module may also have one or more recessed channels 1103 integrated into a surface connecting one or more female keying features to one another such that marine organisms can move between the female keying features when the artificial reef structure is submerged underwater.

Whereas a key feature of the invention are the surface features creating a heterogeneity of different scale habitats built into each module. The irregular shapes and sizes of an artificial reef structures created using a plurality of reef modules provide a vast array of microenvironments, fostering biodiversity by accommodating organisms with different habitat preferences. Micro-scale and meso-scale habitat structures are designed into each of the individual reef modules. While meso-scale and macro-scale habitats are formed when a plurality of reef modules are assembled together.

In embodiments, artificial reef modules incorporate a diverse range of habitats, including crevices, holes, and spaces between reef modules that mimic the spaces between naturally occuring coral branches or rocks. These habitats vary in size, from small crevices that can accommodate tiny invertebrates to larger spaces suitable for fish and other larger organisms. Fractal dimensions ranging from 1.7-1.95 and up to as much as 2.5 are used in the design to represent the complex and self-repeating structures observed in marine ecosystems.

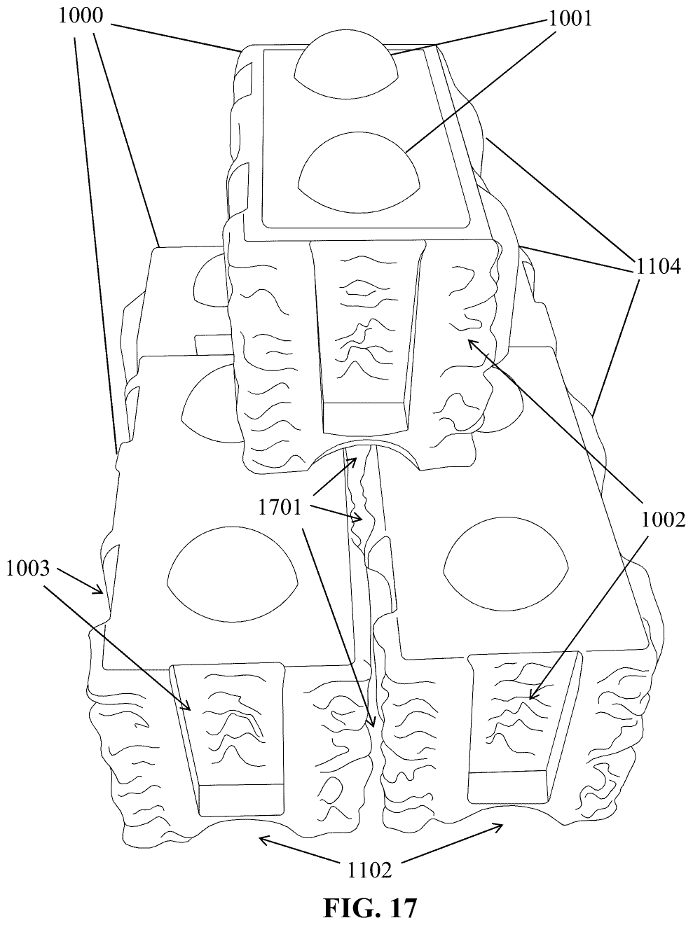

Referring now to FIGS. 17 & 18, surface features 1002 of each reef module provide micro-scale habitats for marine organisms. The material making up each reef module provides a micro-level roughness on the outer surface of the modules. Microhabitat features support the settlement and recruitment of planktonic juvenile organisms, and at this scale will have dimensions on the order of millimeters to centimeters. The surface roughness of a reef module cast in concrete serves as one example of a micro-habitat. As can also be seen, the reef modules comprising first male keying features 1001, first female keying features 1102, second male keying features 1104, and second female keying features 1003.

In addition, assembling a plurality of reef modules forms meso-scale habitat features 1701 for marine organisms. Meso-scale features are designed to support the small to medium-sized organisms and include small caves, crevices, and hiding spots. These features will range from centimeters to decimeters in size and will depend on the targeted organisms. In embodiments, meso-scale habitats are provided by keying features extending enough to hold the adjoining modules apart so as to form gaps between opposing surfaces of adjoining modules. Meso-scale features are also provided by rounded edges of reef modules which also serve to form gaps between adjoining modules

Lastly, assembling a plurality of reef modules to form an artificial reef structure 900 (see FIG. 9) forms macro-scale habitats (e.g., caverns and caves). A plurality of reef modules may be assembled into separate sections: one or more spur sections, one or more crest sections, and/or one or more berm sections. The one or more sections disposed proximately to each other to form an artificial reef structure 900 having macro-scale habitats The macro-scale habitats are formed by the gaps between adjacent reef sections (i.e., grooves) which accommodate larger fish and predators. Macro-scale habitats will have dimensions ranging from decimeters to meters, depending on the size of the targeted marine life.

Referring to FIG. 9, reef scale features are achieved by combining one or more spur section 902, crest sections 903, and berm sections 904, and at the scales of meters to tens of meters will provide the habitat and induce the circulation needed for the development of a healthy ecosystem.

The incorporation of the multi-scale roughness features will be implemented based on the manufacture method techniques used. For dry-casting, wet-casting, or 3D concrete printing, the reef modules that make up the larger artificial reef structure are designed to be customizable, modular, interlocking, and stackable. Keying features on one or more surfaces of a module may be based on a tapered dovetail design to facilitate ease of fit and enhance resistance to lifting and separating. Keying features in the shape of spherical protrusions and recesses are designed to have the most flexibility in allowable stacked configurations. In embodiments, any of the keying features may also double as feet designed to imbed in base/bedding material to increase friction and resist sliding. The reef modules that will be placed in an exposed configuration (i.e., surface/exterior modules) have multi-scale roughness features. Reef modules placed in an interior configuration may be identical to the exterior/surface modules or may be of simpler design. The first inner layer of modules may be comprised of cast concrete with larger scale features (e.g., holes) to minimize material use, allowing for fluid flow through the structure and facilitating growth of a marine habitat.

Manufacturing techniques may make possible the ability to cast the structure in its entirety (or in individual sections) in situ, either by 3D printing or using a rapidly deteriorating form. In this case the there are no reef modules to place, and the surface roughness features will be cast in place and the volume of material used may be reduced by setting an infill parameter or casting over a core as described above.

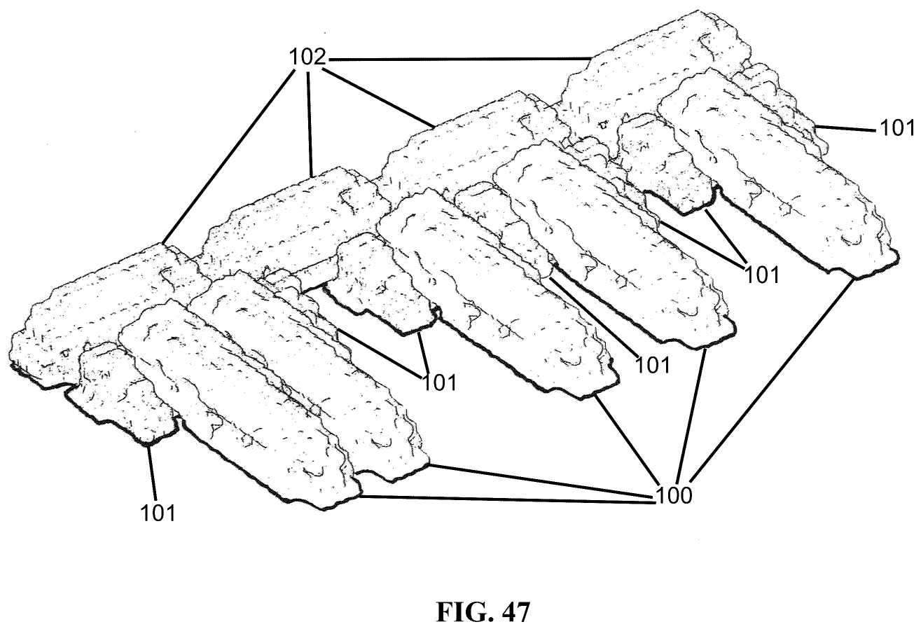

Referring to FIG. 47, an artificial reef structure may be comprised of reef sections instead of reef modules. An artificial reef structure may comprise a combination of one or more spur sections 100, one or more crest sections 102, and one or more berm sections 101. In this embodiment, there are no individual reef modules to assemble and place. The surface roughness features will be cast in place and the total volume of material used may be reduced by setting an infill parameter or casting over a core as described above. It is also possible to cast the individual sections (or a complete artificial reef structure) including all the rugose design features in a dry-dock and then float the reef sections to the deployment site, and sink. The design of the invention allows for the modification of the dimensions of individual sections based on water depth and incident wave properties (e.g. wave period, wavelength, and wave height). The length of an artificial reef (parallel to the shoreline) and the ratio of spur sections to groove sections will be determined on a site-by-site basis based on the design needs of the project.

Both the SAG sections and the crest sections contribute to wave dissipation under varying conditions, so it is critical to include both aspects in the design. The SAG sections dissipate more wave energy under higher wave conditions at low tide, and the reef crest section(s) dissipate more wave energy during high tides and smaller wave conditions. Since the goal is to attenuate larger waves that are more erosive, the bulk of the volume of the structure may be allocated to the spurs, but this is not necessarily the case in all SAGARM implementations.

With regards to wave attenuation, there are numerous parameters involved when designing the optimal dimensions of the SAGARM, the critical parameters including, but not limited to, spur length, crest width, groove width, incident wave height, wave period, and a set depth under varying tidal conditions. Other design parameters may also include the spur height and spur width.

Naturally occurring SAG reefs vary greatly worldwide, but may generally be classified using four different categories:
Class 1-Deep and disconnected (DaD),
Class 2-Exposed to wave energy (EWE),
Class 3-Long and protected (LaP), and
Class 4-Short and protected (SaP)

Since an objective of the SAGARM artificial reefs are to attenuate wave energy at the coastline, in an exemplary embodiment, the configuration of the SAGARM artificial reefs of the invention may mimic the Class 2 SAG reefs. Embodiments may also mimic the other classes of SAG reefs.

In an exemplary, non-limiting embodiment used for concept validation computer simulation and modeling, the water depth at the shoreward end of the spur and the beginning of the crest was chosen to be 6 m, and the spur height was chosen to be 4.8 m, based on tidal conditions in Moloka'i Hawaii. From an engineering perspective, the low submergence height was also selected because submerged breakwaters with a smaller crest submergence value have a lower transmission coefficient. Additionally, the spur width w remained constant at 5 m to reduce the number of variables changed and was concluded to not be a main contributor to the hydrodynamics. Lastly, a roughness height of 0.14 m was implemented on the spurs to simulate the roughness of corals.

To perform the computational fluid dynamics (CFD) analysis, the system was analyzed using computer modeling techniques. Once installed, the stereolithography meshes were imported into the software. The sections were scaled to reasonable dimensions that aligned with the literature, and test simulations were run. FLOW-3D® HYDRO is a valuable tool for this problem since the program uses the FAVORTM (Fractional Area/Volume Obstacle Representation) method. This approach is well suited for complex geometries since it defines the mesh with fractional face areas and volumes providing accurate outlines of the mesh rather than rigid cell block outlines of the structure. The model is also able to account for the roughness of the structure by incorporating a roughness height value for each module into the shear stress equations for turbulent flow with an additional term added to the viscosity.

The simulation was set up with two spurs, one berm in between the spurs, and two crests behind the spur modules.

For simulation and computer modeling, an overall cell size of 0.2 m was used which resulted in 11,684,100 cells in the mesh. To decrease computation time and file size, a variable mesh was used in the x-direction starting at 1 m at the x-minimum boundary that gradually transitioned to 0.2 m roughly 3 m before the structure. The mesh then transitioned again roughly 3 m after the structure from a 0.2 m cell size to a 1 m cell size at the x-maximum boundary. The boundary conditions for the mesh block are provided in Table 1 below.

TABLE 1
Boundary conditions for the mesh in FLOW-3D ® HYDRO.

| Boundary | Type |
|---|---|
| X Minimum (Forced Inflow Boundary) | Stokes and Cnoidal Wave |
| X Maximum (Outflow Boundary) | Wave Outflow |
| Y Minimum (Wall Boundary) | Symmetry |
| Y Maximum (Wall Boundary) | Symmetry |
| Z Minimum (Bottom Boundary) | Symmetry |
| Z Maximum (Upper Boundary) | Pressure |

Stokes and Cnoidal (Fourier series method) waves were set to propagate from the inflow boundary towards the outflow boundary. The wave outflow condition creates a mathematical continuation of the waves flowing out of the tank which is given by the Sommerfield radiation boundary condition:

$$\frac{\partial Q}{\partial t} + C \frac{\partial Q}{\partial x} = 0 \qquad ( 1 )$$

A dampening region that was a minimum of half a wavelength was also placed before the outflow boundary to reduce wave reflection. All symmetry values inform the program to employ a free-slip condition to ensure the normal component of the fluid velocity is equal to zero at that boundary. Lastly, the pressure boundary condition was set to the stagnation pressure condition which informs the model that fluid velocity outside of the boundary is zero, with the fluid here being air in the void set to a constant temperature in this case.

The RNG k-epsilon turbulence model was used which dynamically computes the turbulent mixing length for RANS models as opposed to the k-epsilon model which finds it empirically. This turbulence model was chosen due to its wider applicability and use in other FLOW-3D® simulations that had similar applications.

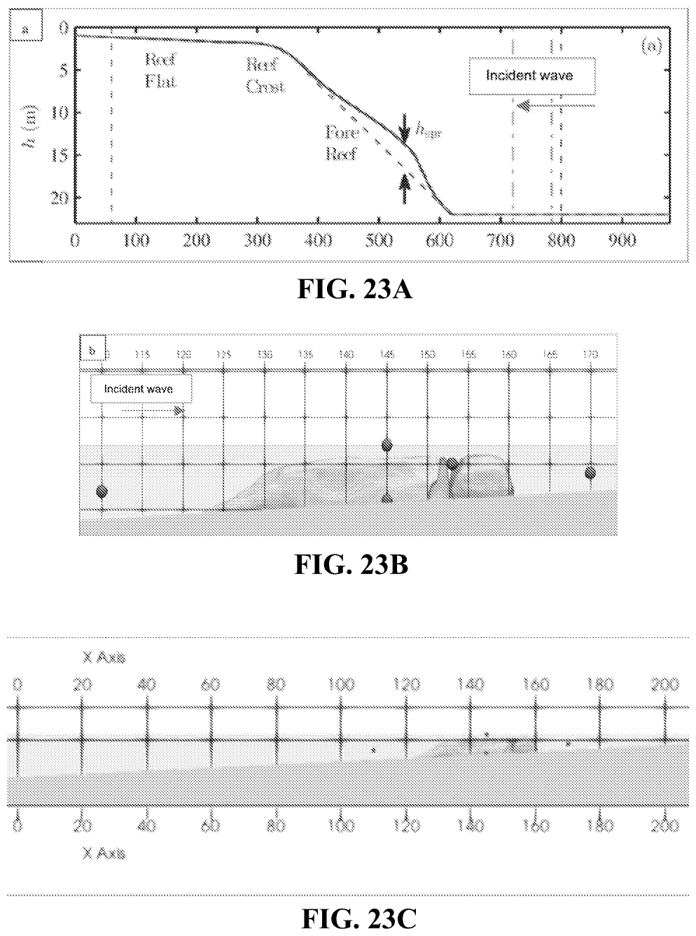

Given the mesh size and parameters provided, the software adjusts the time-step based on stability and convergence throughout the entirety of the simulation. The Courant number must be less than one to meet stability requirements, and additional convergence criterion for implicit solvers must be met. Otherwise, the program reduces the time-step until all requirements are met. This self-corrective mechanism is recommended for default use from Flow Science to ensure appropriate time steps for numerical stability. Multiple probes were placed in the mesh: at the deep-water limit of the sloped bed, approximately 10 m in front of the structure; above the spur and groove; on the groove floor; and at a minimum half a wavelength behind the structure. Final setup based on conditions from Moloka'i, Hawaii is shown in FIGS. 23B & 23C.

The sloped bed allows for larger deep-water waves to be inputted into the mesh to characterize waves that would be depth limited otherwise in a flat bottom mesh. A total number of 21 simulations were run to complete the sensitivity run phase in this project. Control simulations were additionally run to characterize the interaction of the wave with the sloped bed without the reef present to fully understand the structure's role in the wave height reduction.

The hydrodynamics of the artificial SAG system were studied in response to varying wave conditions, tidal ranges, and morphology. Wave height reduction, transmission coefficient, turbulent dissipation within the groove and above the spur, velocity profiles, breaking location, and flow patterns were all studied. Since FLOW-3D® HYDRO provides free surface elevation at probes, the data was exported into MATLAB to find wave height by detrending the free surface elevation data using the zero up crossing method. Data was separated for each wave, and the transmission coefficient was calculated with the equation given by:

$${C}_{t} = \frac{{H}_{2}}{{H}_{1}} \qquad ( 2 )$$

Where H1 is the height seaward of the structure and H2 is the height shoreward of the structure.

This calculation utilized the wave height approximately 10 m before the structure and the wave height at a minimum of half a wavelength after the structure. Wavelength varied between 41 m and 113 m depending on wave conditions in the 6 m water depth. Individual transmission coefficients were calculated for each wave and then averaged to calculate a representative transmission coefficient for each simulation. Wave height reduction percentage was simply calculated using the equation below:

$$H ( \% ) = ( 1 - {C}_{t} ) * 100 \% \qquad ( 3 )$$

Due to different levels of steepening and dissipation before the structure as a result of the sloped bed, other metrics were considered as well. The goal of the following metrics was to only consider final wave heights (past the structure) in the test and control cases to compare how much the wave height changed from the structure as it reaches the shoreline. The first dimensionless parameter is given by:

$$Δ {H}_{2} = \frac{{H}_{2}}{{H}_{2 c}} \qquad ( 4 )$$

with H₂ representing final wave height in the test case with the reef and H_{2c} representing the final wave height in the control simulation without the reef. This method takes into account the fixed sloping rigid bed in the model and how the wave will shoal and break due to shoaling versus shoaling plus the interaction with the structure. The next equation shows the wave height reduction when comparing final wave heights of the study case and the controls shown with:

$$Δ {H}_{2} ( \% ) = ( 1 - Δ {H}_{2} ) * 100 \% \qquad ( 5 )$$

For further analysis FLOW-3DR® s post processing software, FLOW-3D® POST, was used providing powerful visualization of wave breaking and wave-structure interactions. Turbulent dissipation along with the breaking location were main indicators to the locations where most of the wave energy was being attenuated. Velocity profiles additionally indicate direction and magnitude of flow.

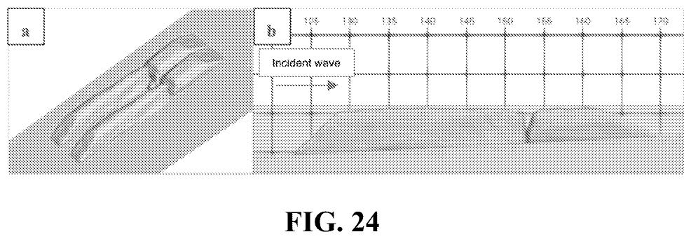

The next portion of the analysis consisted of taking the results from the sensitivity runs to optimize a new base case scenario and inform further testing on parameters of interest. The initial case was adjusted to remain at the low tide condition throughout testing of changes to the structure. The spur and crest modules were both adjusted for optimization of the structure. The new spur was changed to have a consistent submergence with the mean water level and a 1:1 slope at its seaward end, and the crest module was modified to have a 1:2 slope at the back of the structure, FIG. 24.

Final simulations consisted of characterizing the new base case scenario by testing a combination of multiple wave conditions, groove width, spur width, and spur length. The new initial case with testing ranges is tabulated in Table 2 below. Once simulations were complete, they were analyzed utilizing the same methods that were used for the sensitivity runs, and results were compared.

TABLE 2
Final base case scenario and new testing ranges.

| Variable | Base Case | Range | Unit |
|---|---|---|---|
| Sloped Crest | 17 | — | m |
| Length | | | |
| Roughness | 0.14 | — | m |
| Height | | | |
| Spur Height | 4.8 | — | m |
| Bed Slope | 5% | — | — |
| Depth | 5.1 | — | m |
| Wave Height | 2 | 1-4 | m |
| Wave Period | 10 | 8-12 | s |
| Groove Width | 2 | 1-8 | m |
| Spur Length | 30 | 20-60 | m |
| Spur Width | 5 | 2.5-10 | m |

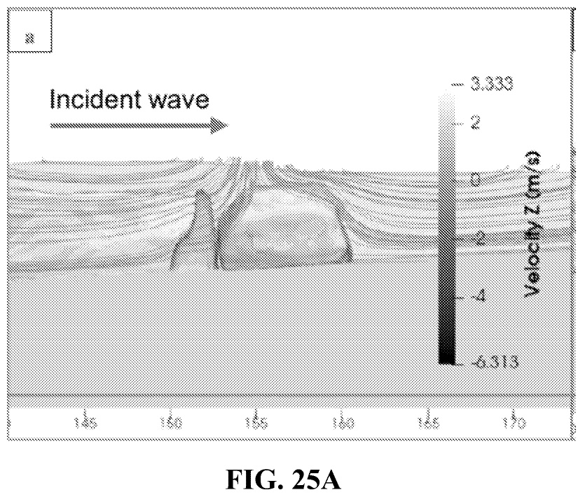

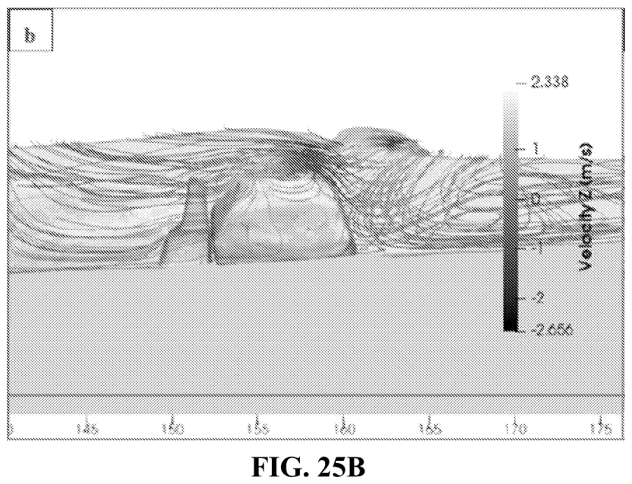

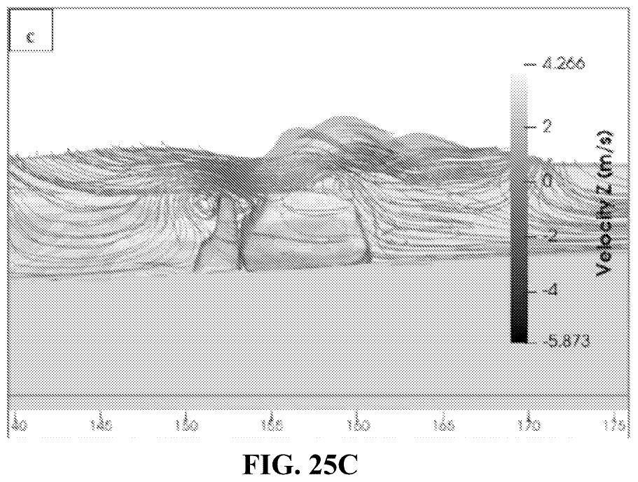

The initial case scenario was first studied to understand how the flows behaved in the base case conditions, and then the results of changing the parameters during the sensitivity runs were analyzed. The most significant change that occurred was when the wave height increased. As wave height increased, the breaking location occurred earlier on the structure, and the velocity and turbulent dissipation increased. There was no breaking in the H=0.5 m case, FIG. 25A. With an increased wave height of 2 m, the wave broke on the crest section, FIG. 25B. At the largest tested wave height, H=4 m, breaking occurred just in front of the crest section, FIG. 25C. A turbulent cell within the groove was also notable in the 4 m wave height condition

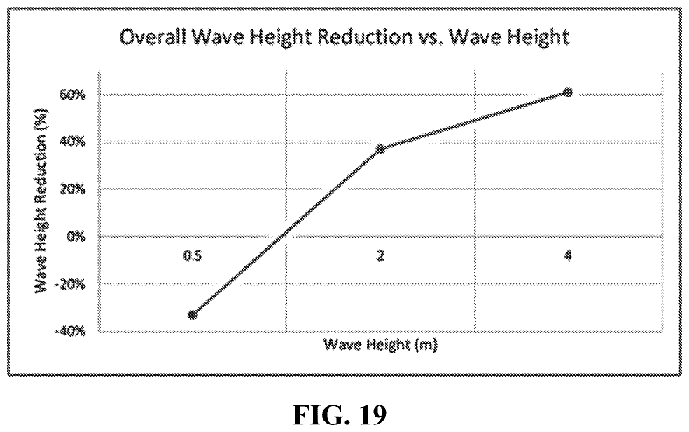

With the largest wave, return flows after wave breaking were noted to be coming through the groove from the lee of the structure to meet the incoming wave. The smaller wave saw an insignificant amount of turbulence and did not break over the structure. Increasing intensity of turbulence and wave breaking correlated to higher wave height reduction trends, FIG. 19.

A negative amount of wave height reduction was observed in the smallest wave height case showing that the wave had steepened at the final probe point and had not broken yet. Overall, as wave height increased, wave height reduction significantly increased likely due to the greater amount of energy that could be attenuated.

Submergence levels, the distance between the top of the structure and the water level, were tested as well. Results showed much higher wave height reduction and increased turbulent dissipation in the lower tide condition (i.e., smallest submergence) compared to the high tide condition (i.e., largest submergence)

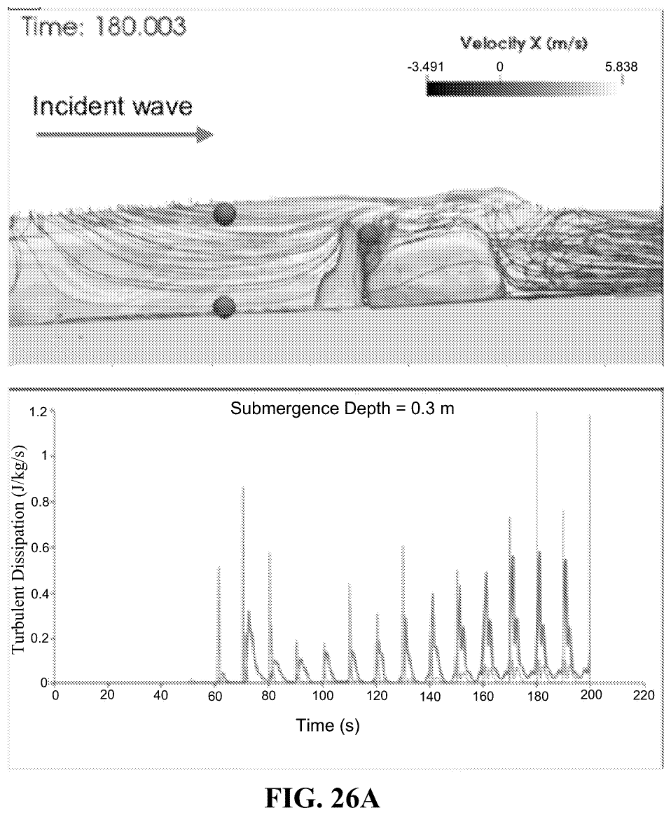

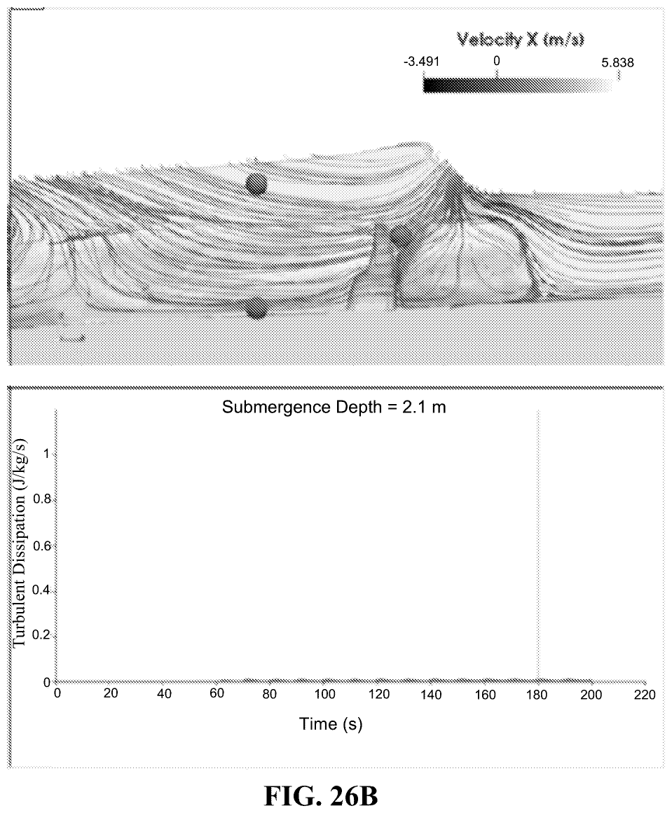

Testing the low tide condition, FIG. 26A, indicated that the wave breaks (upper image) on the structure and resulted in increased turbulent dissipation levels (lower image) in the berm area (probe in between the berm and crest module) as well as on the spur surface. These observations contrasted with the high tide condition, FIG. 26B, where the wave begins to steepen but has not yet broken (upper image) which likely contributed to the negligible amount of turbulent dissipation in the berm area and spur surface (lower image).

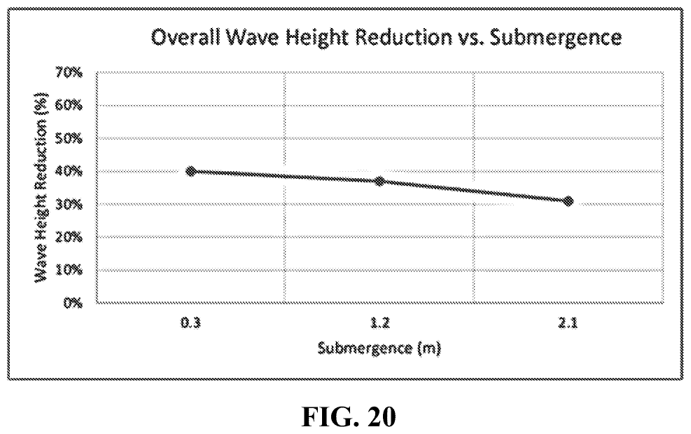

When evaluating wave height reduction as a function of submergence, a linearly decreasing trend was observed, FIG. 20. The decrease in wave height reduction as the submergence increases correlates to the other trends observed with wave breaking and turbulent dissipation. Waves broke earlier on the structure in the low tide condition and much higher levels of turbulent dissipation were observed which likely contributed to the more significant wave height reduction. Since waves were transmitted past the structure in the high tide condition and virtually no turbulent dissipation occurred, the decline in wave height reduction was to be expected.

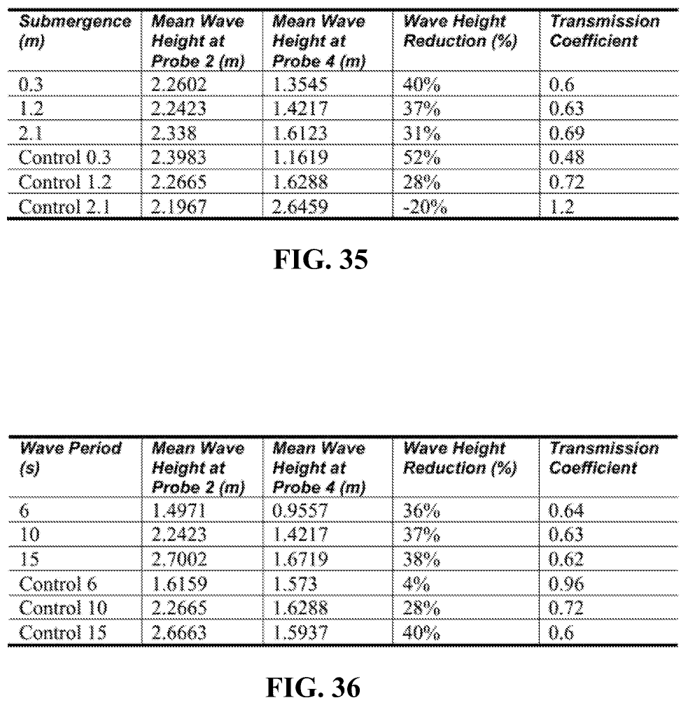

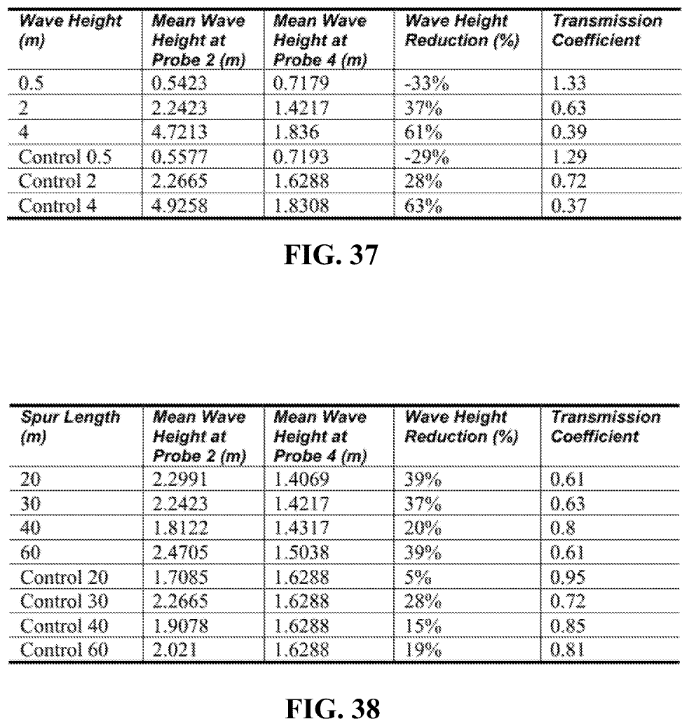

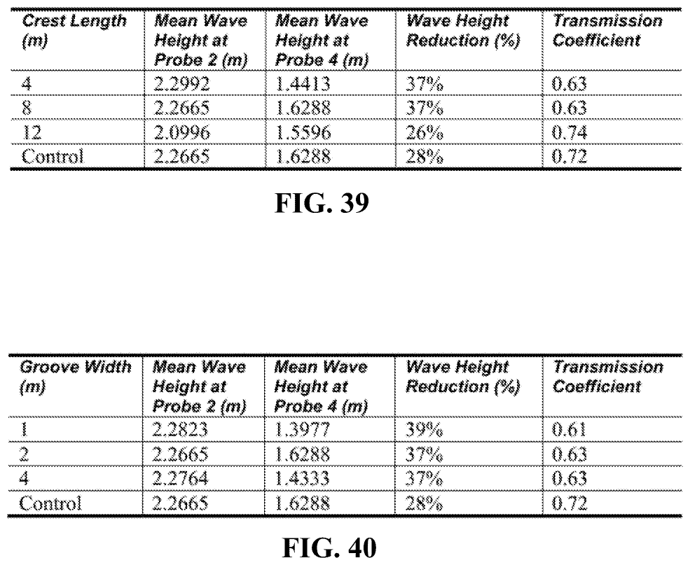

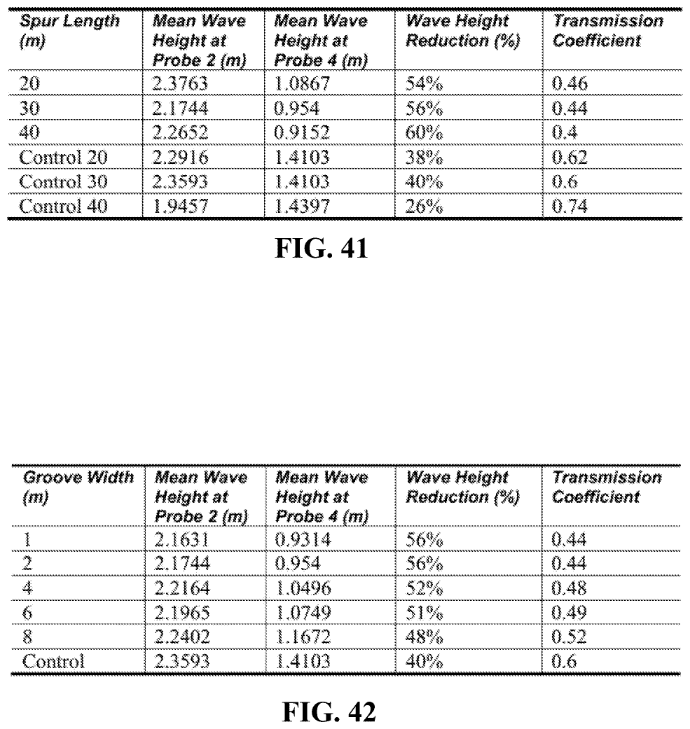

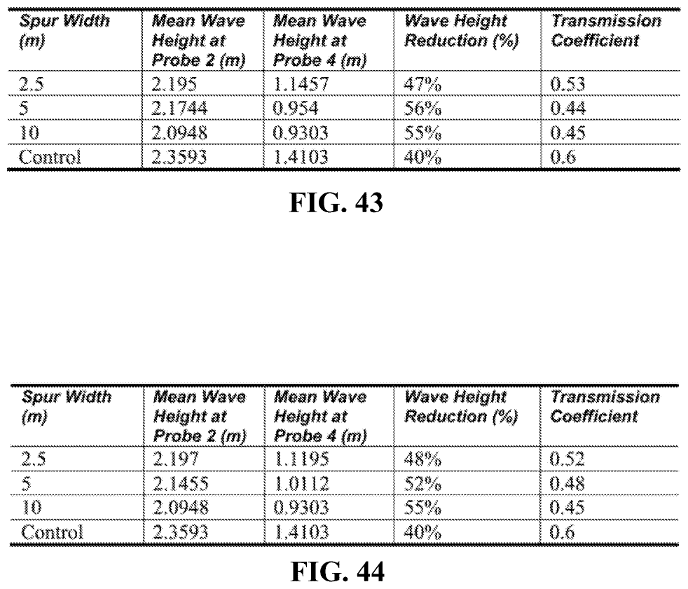

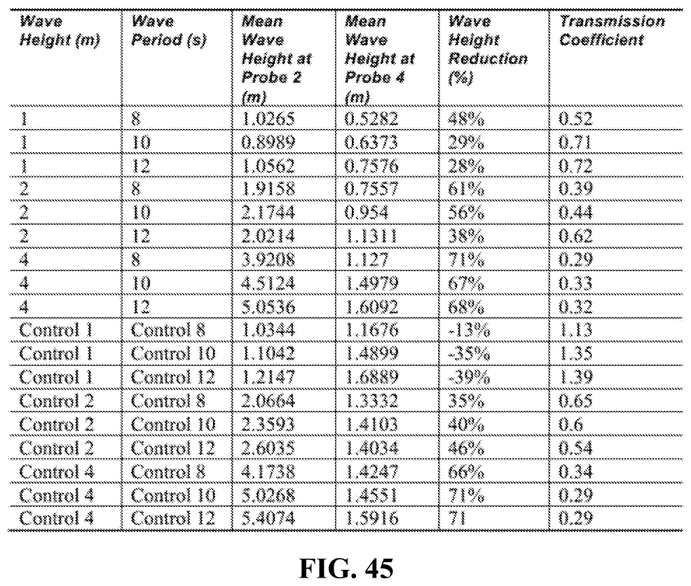

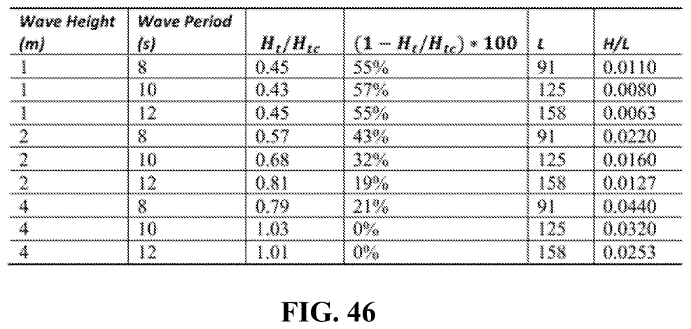

The changes in wave height reduction observed when varying wave period, groove width, spur length, and crest length were not significant in the preliminary testing indicating that the implemented model setup was not as sensitive to these parameters. Mean wave heights at the probe approximately 10 m before the structure and at a minimum of half a wavelength after the structure, wave height reductions, and transmission coefficients from the initial sensitivity runs can be seen in FIGS. 35-46.

The second phase of analysis was aimed to draw information from the initial sensitivity runs to optimize the structure design based on those results. Since there were no significant changes in wave height reduction with adjustments to the module dimensions, it was concluded that the submergence was likely too great for the wave to “feel” the changes of the structure. For more direct interaction with the reef, the new base case simulations were all set to the low tide condition. As discussed previously, the spur was adjusted to have consistent submergence along its length as well as a 1:1 front slope. The testing of different frontal slopes, which included a 1:2 slope and a 1:1 slope, confirmed that a 1:1 slope would result in a higher wave height reduction. Given the concern for scour in the lee of the structure, the eddy formation behind the reef was measured, and the crest's rear slope was extended to disrupt the eddy interacting with the bed. The sloped bed was additionally flattened out after the structure to reduce shoaling impacts.

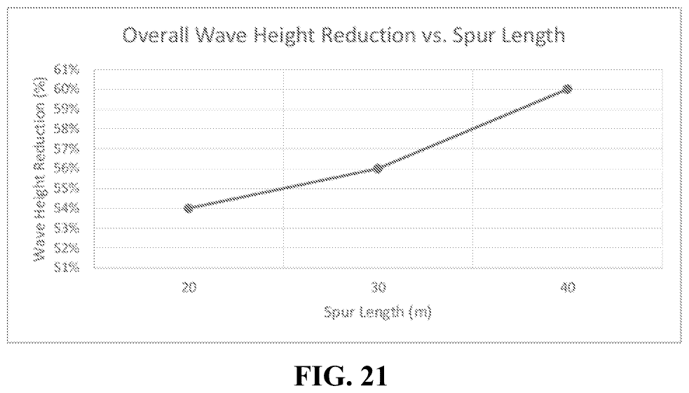

Results showed a higher wave height reduction for the new base case scenario in comparison to the previous one. With the new spur module an increase in wave height reduction was also observed as spur length increased, FIG. 21.

Given the consistent submergence and steep slope at the front of the module, this trend was to be expected since as the spur gets longer, the spur interacts with the wave earlier. Although there was a positively correlated relationship, the changes in wave height reduction are likely not significant enough to justify an increase in volume to the spur.

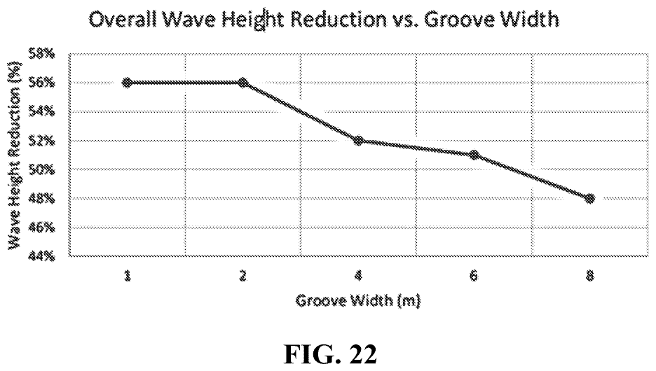

Groove width g was additionally tested again by widening the groove until a significant reduction in effectiveness for reducing wave height occurred which was seen at a groove width of 8 m, FIG. 22.

Since the new spur section has a more vertical component, there is more reflection from the structure, and the larger groove width allows more wave energy to be transmitted.

Metrics of characterized flow direction and magnitude within grooves were noted here with the changes in groove width as well to understand circulation and potential net transport at the seabed within the groove. With the smallest groove width, mean bottom fluid x-velocities were offshore while mean surface fluid x-velocities were onshore. As the groove width increased, mean bottom fluid x-velocities became less negative and were onshore for the two largest groove widths. Surface x-velocities remained onshore but increased in speed as the groove became wider, Table 3 below.

TABLE 3
Groove bottom and surface mean fluid x-
velocities for various groove widths

| | Groove Bottom Average | Groove Surface Average |
|---|---|---|
| Groove Width (m) | Fluid X-Velocity (m/s) | Fluid X-Velocity (m/s) |
| 1 | −0.2635 | 0.0326 |
| 2 | −0.0923 | 0.239 |
| 4 | −0.0152 | 0.3152 |
| 6 | 0.0553 | 0.4126 |
| 8 | 0.0317 | 0.4374 |

Spur width was not initially tested because it is not stated to have significant impacts on its own in certain studies. Researchers report findings related to spur and groove wavelength rather than specifically separating spur width and groove width into separate categories. This metric creates some lack of clarity since two spur and groove wavelengths of the same dimension can have varying groove and spur widths. After the initial sensitivity runs, it was decided, however, that the spur width may be an important metric to be measured.

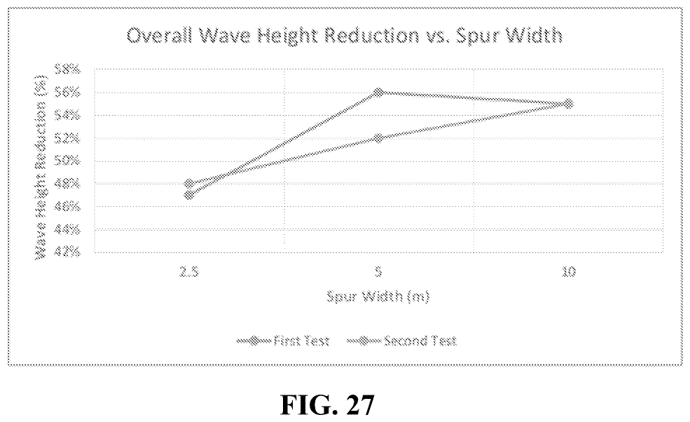

The spur width was tested by dividing the width of the base case spur in half and also doubling it to understand its impact on the hydrodynamics. This testing was initially done by using various mesh widths and setting up the simulations as before with two spurs and one groove. Final wave height did decrease as spur width increased, but there was not as clear a correlation as expected; therefore, a second set of testing was run. With the new method the mesh remained the same width, set at the largest width for the largest spur width. The 10 m spur remained with two spurs and one groove; however, for the narrower spurs they were filled into the mesh with multiple grooves to more accurately reflect a consistent area taken from a representative reef, FIG. 27.

Although changes were minor, it is believed that the second test case better represented the hydrodynamics if a consistent area of a reef was being analyzed.

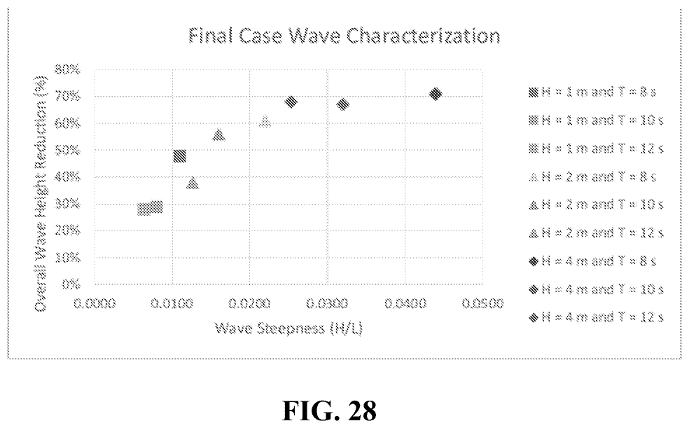

Since wave characteristics greatly impact wave breaking, flow strength, and wave height reduction, a full set of waves with varying wave periods and wave heights were run to fully characterize the relationship between the waves and the new base case structure. FIG. 28 shows the results for the overall wave height reduction due to the bed slope and reef using Equation 3.

As wave height increased, it was evident that dissipation increased as well. When looking at the various changes of wave period with constant wave heights, the shortest wave period condition showed a higher amount of wave attenuation.

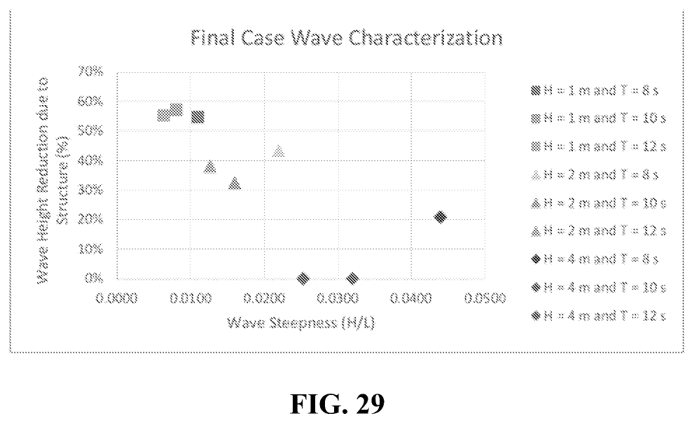

FIG. 29 shows the results for the final wave height reduction that is solely due to the structure. This metric only considered the change between the wave height at the final probe in the test case to the wave height at the final probe in the control case, using Equation 5, and was plotted as a function of wave steepness.

It was evident here that the H=1 m waves were attenuated the greatest from the structure initiating wave breaking, given that a wave with 1 m wave height would not be depth limited otherwise. As wave height increased to 2 m, the wave period had more of an influence. For the shorter wave period and increasing steepness, the structure was responsible for more wave height reduction when compared to the longer wave period. Wave height reduction due to the structure continued to decrease for the largest wave height, where the structure had little influence with wave periods of 10 and 12 seconds and had the greatest reduction at T=8s.

While the results did show certain wave height reduction trends during the sensitivity runs, it should be noted that the wave height reduction due to shoaling on the sloped bed was not subtracted from the overall reduction in the plots shown above; therefore, those numbers do not reflect wave height reduction solely due to the artificial SAG reef breakwater. The results do, however, reflect typical hydrodynamic conditions in this configuration that would be more typical of the environment given the different flow responses from a sloped bed.

Larger waves induced stronger flows due to higher wave energy and broke earlier due to depth limited breaking. Given the larger waves breaking earlier and in front of the crest, more reflection occurred and there was increased turbulence in the groove. The smaller wave saw an insignificant amount of turbulence due to no breaking over the structure, but by allowing smaller waves to be transmitted, normal circulation and sediment transport processes can occur which is beneficial for the overall coastal system. The trend of increased wave energy attenuation occurring as wave height increases follows typical patterns in conventional submerged breakwaters given that there is increased wave shoaling as wave height increases. However, after analyzing the controls, it was evident that most wave height reduction that occurred in the 4 m wave height case occurred due to shoaling on the fixed sloped bed. Since the wave was already depth limited by the time it reached the final probe, the bed initiated wave breaking in the control case as well.

While the wave height reduction did not show significant changes for varying wave period, the wave heights in front of the structure did vary due to different degrees of wave shoaling occurring. The wave height reduction due to the structure was between 36% and 38% for all periods tested, Table 4 below.

TABLE 4
Results for changes in wave period during sensitivity analysis.

| Wave | Probe 2 Mean | Probe 4 Mean | Wave Height |
|---|---|---|---|
| Period (s) | Wave Height (m) | Wave Height (m) | Reduction (%) |
| 6 | 1.5 | 1.0 | 36 |
| 10 | 2.2 | 1.4 | 37 |
| 15 | 2.7 | 1.7 | 38 |

The shortest wave period appeared to have already decreased in wave height before the structure while the other simulations with greater wave periods steepened before breaking on the crest. Ultimately, the shortest wave period resulted in the greatest wave reduction. Additionally, the observation was made that the wave height reduction solely due to the structure was much greater in the T=6 s wave condition in comparison to the longer wave periods.

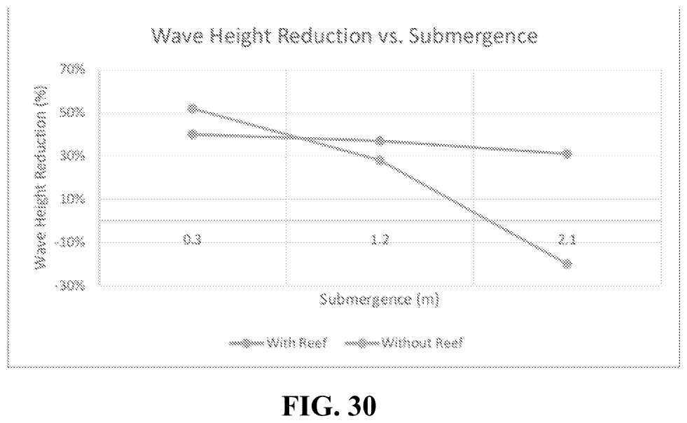

Initial conclusions were that the larger wave height reduction that occurred in the lower submergence condition was likely attributed to greater turbulence and frictional dissipation within the structure since the wave was forced to interact with the reef more than in the high tide condition. At the higher water level most of the waves were transmitted past the structure without interaction, and therefore yielding less energy attenuation. After analyzing the control run simulations, an opposite trend was observed: wave height reduction solely due to the structure was significantly higher than in the low tide condition. These results show that the reef initialized wave breaking in the high tide condition and was responsible for a 51% reduction in wave height, FIG. 30.

These results further reiterate that the reef is most effective in wave height reduction when it is forcing a wave to break.

Spur length was expected to increase wave height reduction since spurs exposed to wave energy areas tend to be longer; however, insignificant changes were seen here likely due to increased submergence at the seaward end of the elongated spur. Adjustment of the spurs morphology to maintain relative submergence across the entire length of the spur was then planned to be incorporated into the final testing. Given the complexity and heterogeneity of a healthy coral reef, the simplification of the roughness height could also have contributed to an underestimate of frictional dissipation in the system.

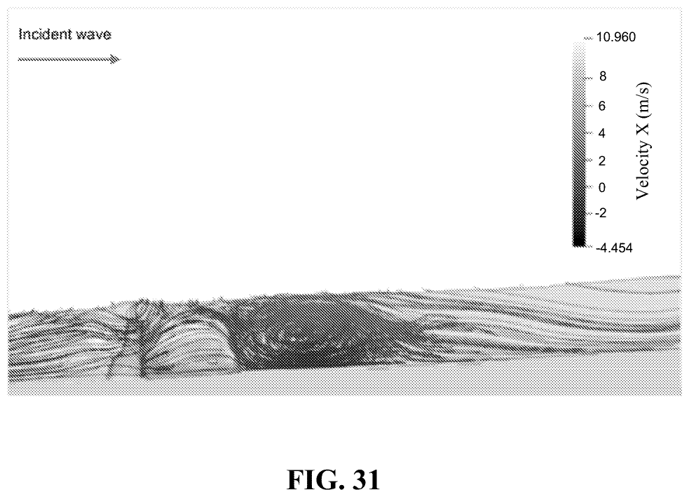

Increasing the crest width did not have significant effects on the wave height reduction or the flow; however, an important observation highlighting scour concerns was able to be made about the design of the structure. While making this reef as similar as possible to nature, it will never be exactly comparable to the system that a SAG and reef crest create. Since the artificial SAG reef here is followed by sandy bottom and not a shallow, rocky reef crest, the waves tend to drop off after the crest as they break and create a large turbulence cell posing a risk for scour, FIG. 31.

Although sediment scour was not studied here, the issue is evident. Because of the potential for scour, the crest module was modified to have a sloping back in the final iterations.

Groove width varies significantly worldwide but tends to be smaller in higher wave energy environments, so a small range of groove widths was tested. Insignificant changes in flow were found. From an engineering perspective these results proved to be beneficial since wider grooves require fewer materials, resulting in a reduction of costs for construction. As a result of these findings, final testing planned to widen the groove until a decline in wave height reduction was observed to find the maximum feasible groove width.

By looking at the wave height reductions of the control runs in comparison to the simulations with the reef, it was concluded that while there was significant wave height reduction in some cases, much of it was attributed to the fixed sloped bed rather than the reef. These comparisons additionally elucidated that the reef is most effective in wave height reduction when it is initiating wave breaking and is less effective if the wave was already going to break from depth limited breaking. Frictional dissipation in the model was likely underrepresented, and it is expected that in a full scale real-life scenario there would be greater reduction in wave height from friction.

Lastly, to reduce the overall number of simulations and streamline the testing process, each adjustment to the artificial SAG reef sections (i.e., changes in crest width, spur length, and groove width) were tested under the same wave and tidal condition.

The new base case proved to be more effective in wave height reduction, likely due to the steeper slope at the front of the structure. Not only does this slope add a more vertical component that should induce more reflection, but it also allows for more volume of the spur to be in the bulk of the module, increasing the overall length of the top portion of the spur.

While the new sloped crest did have a greater volume than the initial crest, it was concluded that allocating more volume to the section would be important since in most cases the wave is breaking directly on it.

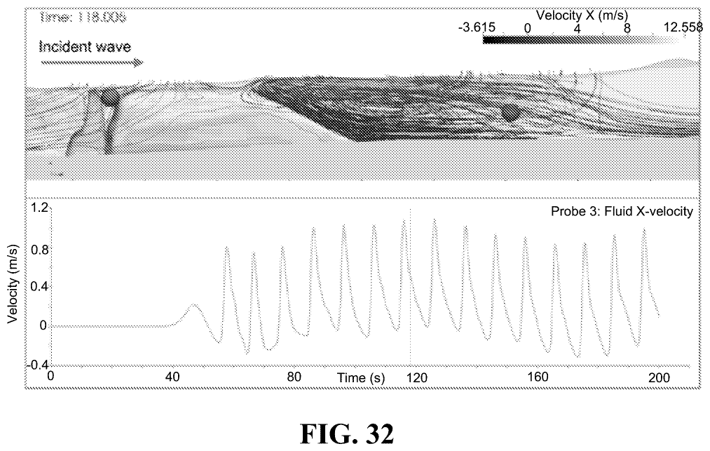

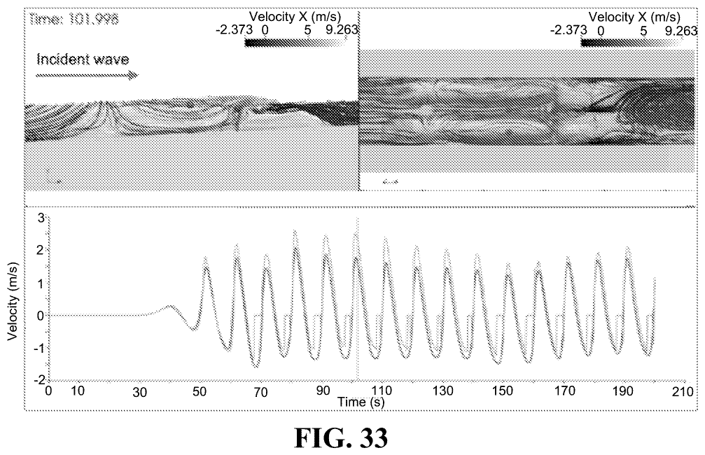

The new slope at the lee of the crest also prevented the large circulation cell from interacting with the bed and reduced scour in the lee of the structure, FIG. 32.

While a circulation cell is still present in the lee of the reef, it is noted that the velocity at probe 3 does not exceed 1 m/s and that most of the eddy now interacts with the crest's slope rather than the seabed.

In the final testing it was observed that wave height reduction decreased as groove width widened, as expected due to more wave energy being transmitted through the groove. For future installment of this structure, groove width should be selected based on needs relating to costs of construction and what wave height reduction is required at a given installment.

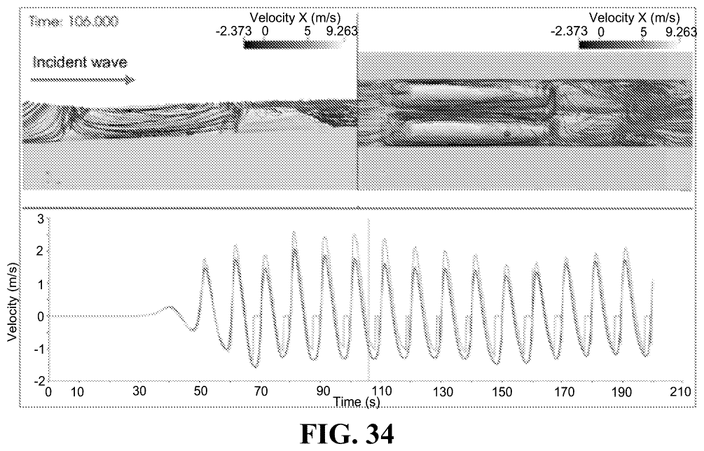

Two circulation cells were observed: one on the lower fore reef that had offshore flow over the spurs and onshore flow over the grooves, with the exception of velocities always onshore at the seabed, and an additional cell on the upper fore reef that had offshore surface velocities and onshore currents near the seabed. SAG formations with shorter SAG wavelengths only had one circulation cell in the shallower area of the reef. While the same results were not observed in the models, it is important to note that these two reefs and models vary significantly. The spurs in Moloka'i, Hawaii are roughly 200 m long, and the artificial SAG reef does not allow flow to completely be transmitted through the grooves. Some wave energy in the lower portion of the water column is reflected by the berm module or rerouted around the berm and through the gap between the crests. While it is impossible to make a direct comparison between the simulations here and the reef in Moloka'i, Hawaii, it is still important to observe these changes in flow for this specific structure and how that impacts circulation and sediment transport. Additionally, as the wave interacts with the structure, velocities are constantly fluctuating from onshore to offshore showing that the corals on the reef would interact with flows of varying direction, FIG. 34.

When the waves break on the reef, they cause an increase in water level which creates a pressure gradient. This pressure gradient encourages circulation within the reef and is responsible for oxygenation and transport of sediment, nutrients, and plankton.

The design of particular installations should consider the changes in net flow at the different depths of the water column as this structure is employed so that scour and shoreline response are controlled. When adding a new structure offshore, changes to the shoreline are expected and it is important to ensure that erosion does not occur at the coastline or near the structure that could reduce stability.

After the final testing of different wave conditions on the new base case reef, the results showed that the structure was responsible for more wave height reduction for the H=Im wave height and the shorter wave periods. These trends are likely due to the fact that the structure is initiating wave breaking when otherwise those waves would not have been depth limited. Additionally, with the shorter wave periods, the trough of the wave is interacting with the structure more which causes further energy losses. The reef is most effective in wave height reduction when initiating wave breaking. With that being said, the structure would likely be more effective in wave height reduction of the larger waves at a higher tide condition or increased submergence because the control case would experience less wave height reduction.

As crest width (B) on a conventional structure increases, wave transmission decreases. While grooves are present in the SAG structure, the spur length still similarly correlates to the crest width, and increased wave height reduction was seen as the spur length increased during final testing. Similar trends in terms of wave height, wave period, and submergence depth were additionally reported from other studies as seen here in overall wave height reduction trends.

It would be expected, in embodiments, that in larger wave scenarios more sediment would be transported resulting in a typical bar-trough system. The structure may impede that transition and limit the sediment motion.

The model proved to be sensitive to changes in wave height, wave period, and depth due to tidal changes. Given the initial results it was deemed that the submergence depth, 2.1 m, was too large for changes in the reef design to impact the wave significantly. The low tide condition was chosen for final testing, and the spur and crest modules were adjusted based on results and observations from sensitivity testing. The spur module was optimized to have consistent submergence with the mean water level to increase wave interaction with the structure, and its front slope was steepened to a 1:1 slope to induce more reflection while also allocating more volume to the main body of the spur. Thus the spur seaward end slope may be varied to achieve a desired reflection. The crest may be adjusted to have a sloped back to reduce the risk of scour in the lee of the structure. Final analysis showed that the computer model is sensitive to morphological changes in spur length, spur width, and groove width. Additionally, it was concluded that while overall wave height reduction increases as wave height increases, the structure itself is most effective in wave height reduction when it forces waves to break that otherwise would not have been depth limited.

When looking at overall wave height reduction trends, the results correlated to other submerged breakwaters in terms of wave height, wave period, submergence depth, and crest width. Although the SAG structure includes grooves, the spur length and crest width are still similar parameters and saw increased levels of wave height reduction as they increased.

When designed incorrectly, any breakwater can result in negative impacts on the shoreline, including erosional hotspots, scour, and reduction of water quality. The sensitivity analyses and final testing performed here aimed to select ranges that were deemed appropriate as initial design steps.

Since this artificial SAG reef structure is a novel design without any preexisting data on it, the wave tank testing is critical for complete validation of the numerical models. Additionally, with correct design the reef poses the ability to induce wave refraction effects. Submerged breakwaters that initiate wave refraction can prevent waves that are at an angle to the shorelines from inducing excess alongshore currents. Given that depth, wave conditions, and sediment transport processes can drastically vary from site to site, any artificial SAG reefs might need to be specifically designed for each site. With appropriate design considerations, this novel invention holds great potential for green infrastructure and coastal resiliency.

Beyond the goal of simply attenuating waves like conventional breakwaters, this design promotes circulation within the spur and groove area that encourages the settlement of benthic flora and fauna and facilitates a healthy environment. A living breakwater helps decrease maintenance and the associated costs, while also promoting life in a new ecosystem. From the engineering perspective there are other benefits to using submerged breakwaters including their ability to let smaller waves pass, which allows normal cross-shore sediment transport processes to occur under mild conditions. Additionally, the submerged SAGARM breakwater of the invention does not disrupt the aesthetics of the beach unlike emergent breakwaters, jetties, and groins of the prior art. Green infrastructure and sustainable practices are important tools in the response to climate change at the global scale. The present SAGARM invention provides a significant improvement in coastal resiliency.

Although these several embodiments have been described and shown in the figures, numerous other changes, substitutions, variations, omissions, alterations, and/or modifications are possible without departing from the scope of the present invention, as defined by the appended claims. The particular embodiments described herein are illustrative only. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Similarly, methods associated with disclosed embodiments may be implemented using more, less, and/or other steps than those described herein, and their steps may be performed in any suitable order.

What is claimed is:

1. A customizable artificial reef structure, comprising:
a plurality of reef modules, wherein each of the plurality of reef modules comprises:
at least one surface having at least one male or female keying feature such that when a first reef module is mated to a second reef module, a gap is formed between opposing surfaces of the first reef module and the second reef module; and
at least one surface having at least one surface feature for providing micro-scale habitats.

2. The customizable artificial reef structure of claim 1, wherein each module of the plurality of reef modules further comprises:
an opposite surface to the at least one surface having at least one male or female keying feature, wherein said opposite surface comprises at least one complementarily shaped keying feature to the at least one male or female keying feature of the at least one surface.

3. The customizable artificial reef structure of claim 2, further comprising one or more reef sections, wherein the one or more reef sections are formed by seating at least one keying feature of a first reef module to at least one complementarily shaped keying feature of a second reef module.

4. The customizable artificial reef structure of claim 3, wherein each section of the one or more reef sections is further defined as a spur section, a crest section, or a berm section.

5. The customizable artificial reef structure of claim 4, wherein a spur section is defined as having a seaward end, a shoreward end, and a spur length;
wherein a spur section is arranged such that the seaward end is oriented in a seaward direction, and the shoreward end is oriented in a shoreward direction;
a crest section is defined as having a seaward side, a shoreward side, and a height;
wherein a crest section is arranged to abut the shoreward end of a spur section;
wherein a plurality of crest sections may be arranged to form a line of crests, the line of crests having a shoreward surface, a seaward surface, and a height.

6. The customizable artificial reef structure of claim 5, wherein the arrangement of two or more spur sections forms a groove between adjacent spur sections.

7. The customizable artificial reef structure of claim 6, wherein each spur section of the plurality of spur sections is further defined has having a height, and wherein each crest section of the plurality of crest sections is defined has having a same height as each of the spurs.

8. The customizable artificial reef structure of claim 7, wherein the spur sections are arranged such that a longitudinal axis of each spur section of the plurality of spur sections is parallel or substantially parallel with a longitudinal axis of each of the other spur sections of the plurality of spur sections.

9. The customizable artificial reef structure of claim 8, wherein each groove is further defined as having a shoreward end, a seaward end, and width, wherein said width is defined as the distance between the adjacent spur sections forming the groove.

10. The customizable artificial reef structure of claim 9, wherein the shoreward end of each groove terminates against the seaward surface of the line of crests.

11. The customizable artificial reef structure of claim 10, further comprising a berm section disposed in at least one groove.

12. The customizable artificial reef structure of claim 11, wherein the berm section abuts the seaward surface of the line of crests.

13. A method for making a spur and groove artificial reef structure, the method comprising:
assembling a plurality of reef modules to form one or more spur section(s), crest section(s), or berm section(s).

14. The method of claim 13, wherein assembling the plurality of reef modules further comprises seating a keying feature of a first reef module to a complementarily shaped keying feature of a second reef module.

15. The method of claim 14, wherein seating the keying features of the plurality of modules is performed out of a body of water.

16. The method of claim 15, further comprising transporting the assembled reef modules to a project site and submerging the assembled reef modules under water.

17. The method of claim 14, wherein assembling a plurality of reef modules further comprises seating the keying features of the reef modules while the reef modules are submerged under water.

18. An artificial reef module comprising:
at least one surface having at least one male or female keying feature such that when a first reef module is mated to a second reef module, a gap is formed between opposing surfaces of the first reef module and the second reef module; and
at least one surface having at least one surface feature for providing micro-scale habitats.

19. The artificial reef module of claim 18, further comprising:
an opposite surface to the at least one surface having at least one male or female keying feature, wherein said opposite surface comprises at least one complementarily shaped keying feature to the at least one male or female keying feature of the at least one surface.

20. An artificial reef structure, comprising:
one or more spur sections, wherein each of the one or more spur sections is defined as having a seaward end, a shoreward end, and a spur length;
wherein each of the one or more spur sections is arranged such that the seaward end of each spur section is oriented in a seaward direction, and the shoreward end of each spur section is oriented in a shoreward direction; and
one or more crest sections, wherein each of the one or more crest sections is defined as having a seaward surface, a shoreward surface, and a height;
wherein a plurality of the one or more crest sections are arranged to abut the shoreward ends of the one or more spur sections so as to form a line of crests along the shoreward ends of the one or more spur sections.

21. The artificial reef structure of claim 20, further comprising:
one or more berm sections disposed between adjacent spur sections, wherein the one or more berm sections abuts a seaward surface of the line of crests.

22. The artificial reef structure of claim 20, wherein:
one or more spur sections and one or more crest sections are disposed on an ocean floor to form a SAG reef area;
wherein the SAG reef area is defined as an area of ocean floor having a length and a width, the length defined as a wavelength equal to the length of the line of crests, and the width defined as the length of the spurs forming the plurality of spurs plus the width of the crests forming the plurality of crests; and
wherein the artificial reef is disposed on an ocean floor surface at a submerged depth, wherein the submerged depth is defined as the depth of the water at the SAG reef area; and
at least one parameter from the group of parameters defined as spur height, spur length, wavelength, groove width, cross-shore slope, submerged depth, and crest width are selected so as to achieve a desired hydrodynamic and circulation of ocean water effect in the SAG reef area.

23. The artificial reef structure of claim 22, wherein the selection of at the least one parameter results in up to a fifty-seven (57%) reduction in incoming wave height.

24. The artificial reef structure of claim 22, wherein each spur and crest further include crevices, holes, or spaces.

25. The artificial reef structure of claim 24, wherein said crevices, holes, or spaces are arranged in fractal dimensions ranging from 1.7-1.95 and up to as much as 2.5 to represent the complex and self-repeating structures observed in marine ecosystems.

26. The artificial reef structure of claim 25, wherein micro-scale roughness features are implemented into the surface of the structure.
